(19) United States
(12) Patent Application Publication
(10) Pub. No.: US 2026/0034676 A1
(43) Pub. Date: Feb. 5, 2026

(54) METROLOGY SYSTEM WITH POSITION AND ORIENTATION TRACKING UTILIZING MEASUREMENT SPOTS PRODUCED BY LIGHT BEAMS

(71) Applicant: Mitutoyo Corporation, Kanagawa-ken (JP)

(72) Inventor: Norman LAMAN, Kenmore, WA (US)

(21) Appl. No.: 18/789,461

(22) Filed: Jul. 30, 2024

(51) Int. Cl. B25J 9/16; G01B 11/00

(52) U.S. Cl. CPC B25J 9/1697; B25J 9/1664; G01B 11/002

(57) ABSTRACT

A metrology system is provided for use with a movement system that moves an end tool. The metrology system includes a sensor configuration, a light beam source configuration and a processing portion. The light beam source configuration directs light beams to light beam sensors to indicate a position and orientation of the light beam source configuration. The light beam source configuration is coupled to the end tool or to an end tool mounting configuration. Light beams that are directed toward the light beam sensors produce measurement spots in positions on the light beam sensors that cause the light beam sensors to produce corresponding measurement signals. A modulation portion is configured to modulate a current of one or more light sources of the light beam source configuration. The processing portion processes the measurement signals from the sensor configuration to determine a position and orientation of the light beam source configuration.

### BACKGROUND

### Technical Field

This disclosure relates to metrology and movement systems, and more particularly to a metrology system that may be utilized with a movement system, such as a robot, for tracking position and orientation.

### Description of the Related Art

Manufacturing, workpiece inspection, and other processes frequently use mechanical movement systems for performing certain functions. For example, robot systems or other movement systems may be utilized to move an end tool for performing certain operations (e.g., in relation to workpiece inspection, manufacturing, etc.). For certain applications, various types of robots that may be utilized include articulated robots, selective compliance articulated robot arm (SCARA) robots, Cartesian robots, cylindrical robots, spherical robots, etc. As one example of components that may be included in a robot, a SCARA robot system (e.g., which may be a type of articulated robot system) may typically have a base, with a first arm portion rotationally coupled to the base, and a second arm portion rotationally coupled to an end of the first arm portion. In various configurations, an end tool may be coupled to an end of the second arm portion (e.g., for performing certain work and/or inspection operations). Such systems may include position sensors (e.g., rotary encoders) utilized for determining/controlling the positioning of the arm portions and correspondingly the positioning of the end tool. In various implementations, such systems may have a positioning accuracy of approximately 100 microns, as limited by certain factors (e.g., the rotary encoder performance in combination with the mechanical stability of the robot system, etc.).

U.S. Pat. No. 4,725,965 (referred to herein as the '965 patent), which is hereby incorporated herein by reference in its entirety, discloses certain calibration techniques for improving the accuracy of a SCARA system. As described in the '965 patent, to calibrate a kinematic model, arm portions are placed in a first configuration to locate an end tool above a fixed datum point. Then, the arm portions are placed in a second angular configuration to nominally locate the end tool again in registration with the datum point. The error in the kinematic model is computed from the shift in the position of the end tool from the datum point when the arm portions are switched from the first to the second angular configuration. The kinematic model is then compensated in accordance with the computed error. The steps are repeated until the error reaches zero, at which time the kinematic model of the SCARA robot is considered to be calibrated. As further described in the '965 patent, the calibration technique may include the use of certain cameras.

While techniques such as those described in the '965 patent may be utilized for calibrating a robot system, in certain applications it may be less desirable to utilize such techniques (e.g., which may require significant time and/or may not provide a desired level of accuracy for all possible orientations of a robot during certain operations, etc.). A system that can provide improvements with regard to such issues (e.g., for increasing the reliability, repeatability, speed, etc., of position and orientation determination for processes such as workpiece measurements, manufacturing, etc.) would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to one aspect, a metrology system is provided for use with a movement system that moves an end tool. The movement system comprises a movable configuration and a motion control system. The movable configuration comprises an end tool mounting configuration that an end tool is configured to mount to. The motion control system is configured to control an end tool position and orientation, based at least in part on controlling the movable configuration so as to move at least a portion of an end tool that is mounted to the end tool mounting configuration within a movement volume.

The metrology system comprises a sensor configuration, a light beam source configuration and a processing portion. The sensor configuration comprises a plurality of light beam sensors located at fixed positions. The light beam source configuration is configured to direct light beams to light beam sensors of the sensor configuration to indicate a position and orientation of the light beam source configuration. The light beam source configuration is configured to be coupled to at least one of an end tool or the end tool mounting configuration. At least some light beams that are directed toward the light beam sensors are configured to produce measurement spots in positions on the light beam sensors that cause the light beam sensors to produce corresponding measurement signals. A modulation portion is configured to modulate a current of one or more light sources of the light beam source configuration. The processing portion is configured to process measurement signals from the light beam sensors of the sensor configuration to determine a position and orientation of the light beam source configuration.

In accordance with another aspect, a method is provided for operating the metrology system with the movement system that moves an end tool. The method includes operating the light beam source configuration to direct light beams to light beam sensors of the sensor configuration to indicate a position and orientation of the light beam source configuration, wherein the modulation portion modulates a current of one or more light sources of the light beam source configuration. Measurement signals from the light beam sensors are processed. A position and orientation of the light beam source configuration are determined based at least in part on the processed measurement signals.

### BRIEF DESCRIPTION OF THE SEVERAL VIEWS OF THE DRAWINGS

FIG. 1 is a block diagram of a first exemplary implementation of a movement and metrology system;

FIG. 2 is a block diagram of control and processing portions of the system of FIG. 1;

FIGS. 3A and 3B are diagrams of implementations of a light beam source portion of a light beam source configuration such as may be utilized in the system of FIG. 1;

FIGS. 4A and 4B are diagrams of respective movement volumes as surrounded by respective metrology frame volumes which are defined at least in part by respective sensor configurations;

FIGS. 5A-5H are diagrams illustrating four example light beams of a light beam source configuration and corresponding measurement spots on four sensors of a sensor configuration for different positions and orientations of the light beam source configuration;

FIG. 6 is a diagram illustrating measurement spots as formed by light beams from a light beam source configuration on a light beam sensor;

FIGS. 7A and 7B are diagrams illustrating implementations of measurement spots with structure;

FIG. 8 is a diagram illustrating an implementation of a measurement spot as formed utilizing a modulation portion which addresses certain issues related to the measurement spots of FIGS. 7A and 7B;

FIGS. 9A and 9B are diagrams illustrating a simplified example of measurement spots with structure;

FIG. 10 is a diagram illustrating a simplified example of a measurement spot as formed utilizing a modulation portion which addresses certain issues related to the measurement spots of FIGS. 9A and 9B; and

FIG. 11 is a flow diagram illustrating one exemplary implementation of a routine for operating a metrology system.

### DETAILED DESCRIPTION

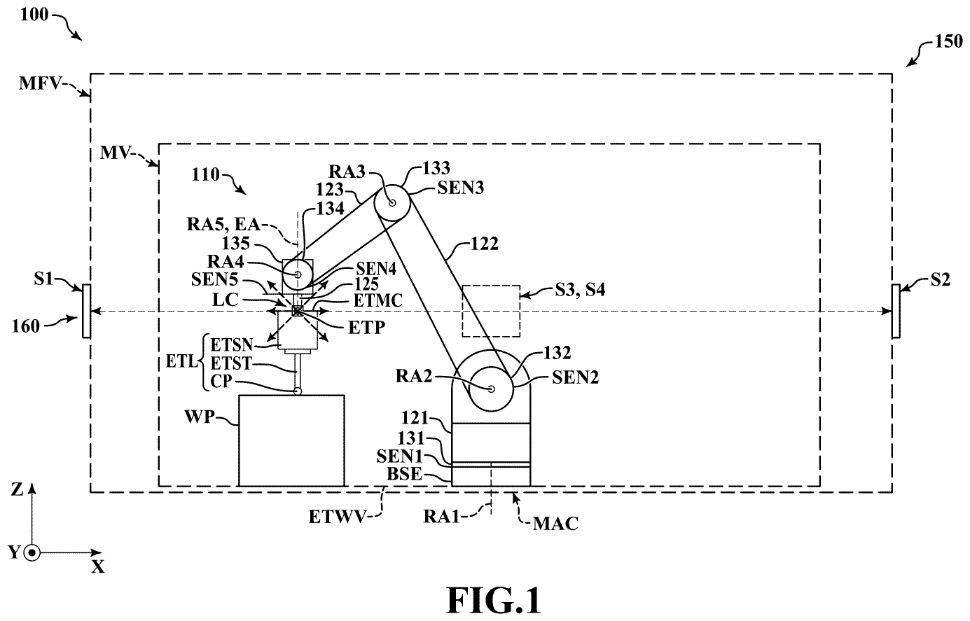

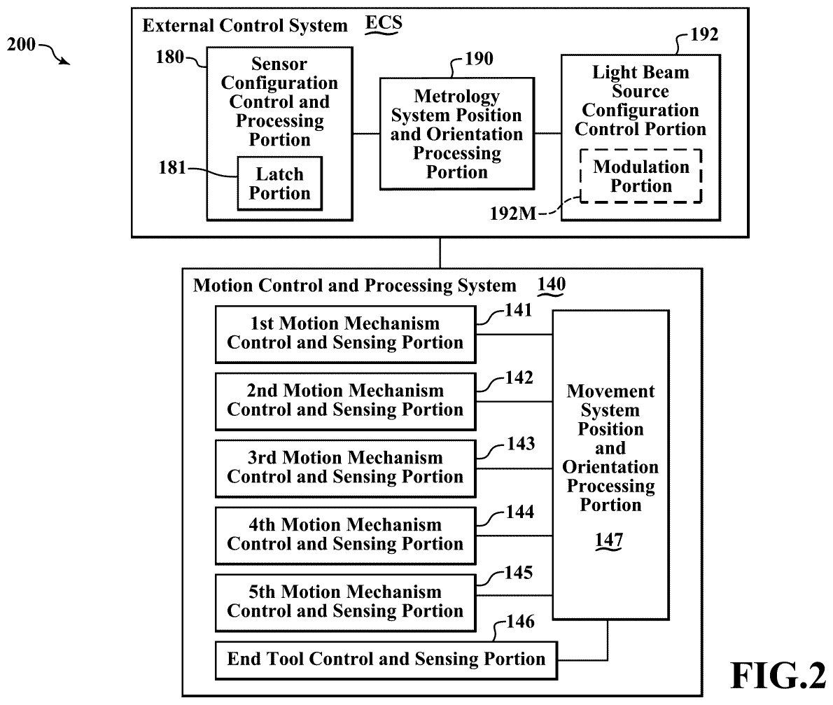

FIG. 1 is a block diagram of a first exemplary implementation of a movement and metrology system 100 including a movement system 110 and a metrology system 150. The movement system 110 (e.g., an articulated robot) includes a movable configuration MAC (e.g., a movable arm configuration) and a motion control and processing system 140 (FIG. 2). The metrology system 150 includes a sensor configuration 160, a light beam source configuration LC, and a metrology system position and orientation processing portion 190 (FIG. 2). In the configuration of FIG. 1, the light beam source configuration LC (e.g., illustrated as directing arrowed light beams in different directions, including toward the light beam sensors S1 and S2) is coupled to the end tool ETL. As will be described in more detail below, the metrology system 150 may be utilized for tracking a position and orientation (e.g., of the end tool ETL as moved by the movement system 110).

In the example of FIG. 1, the movable configuration MAC includes a lower base portion BSE, arm portions 121-125, motion mechanisms 131-135, position sensors SEN1-SEN5, and an end tool mounting configuration ETMC. In various implementations, some or all of the arm portions 121-125 may be mounted to respective motion mechanisms 131-135 at respective proximal ends of the respective arm portions 121-125. In the example of FIG. 1, some or all of the motion mechanisms 131-135 (e.g., rotary joints with corresponding motors) may enable motion (e.g., rotation) of the respective arm portions 121-125 (e.g., about respective rotary axes RA1-RA5). In various implementations, the position sensors SEN1-SEN5 (e.g., rotary encoders) may be utilized for determining the positions (e.g., angular orientations) of the respective arm portions 121-125.

In various implementations, the movable configuration MAC may have a portion that is designated as a terminal portion (e.g., the fifth arm portion 125). In the example configuration of FIG. 1, the end tool mounting configuration ETMC is located proximate to (e.g., located at) the distal end of the fifth arm portion 125 (e.g., designated as the terminal portion), which corresponds to a distal end of the movable configuration MAC. In various alternative implementations, a terminal portion of a movable configuration may be an element (e.g., a rotatable element, etc.) that is not an arm portion but for which at least part of the terminal portion corresponds to a distal end of the movable configuration where the end tool mounting configuration ETMC is located.

In various implementations, the end tool mounting configuration ETMC may include various elements for coupling and maintaining the end tool ETL proximate to the distal end of the movable configuration MAC. For example, in various implementations, the end tool mounting configuration ETMC may include an autojoint connection, a magnetic coupling portion and/or other coupling elements as are known in the art for mounting an end tool ETL to a corresponding element. The end tool mounting configuration ETMC may also include electrical connections (e.g., a power connection, one or more signal lines, etc.) for providing power to and/or sending signals to and from at least part of the end tool ETL (e.g., to and from the end tool sensing portion ETSN).

In various implementations, the end tool ETL may include the end tool sensing portion ETSN and an end tool stylus ETST with a contact point CP (e.g., for contacting a surface of a workpiece WP). The fifth motion mechanism 135 is located proximate to the distal end of the fourth arm portion 124. In various implementations, the fifth motion mechanism 135 (e.g., a rotary joint with a corresponding motor) may be configured to rotate the fifth arm portion 125 about a rotary axis RA5. In some implementations, the fifth motion mechanism 135 may also or alternatively include a different type of motion mechanism (e.g., a linear actuator) that is configured to move the fifth arm portion 125 linearly (e.g., up and down). In any case, the end tool ETL is mounted to (e.g., coupled to) the end tool mounting configuration ETMC, and has a corresponding end tool position ETP with corresponding coordinates (e.g., x, y and z coordinates). In various implementations, the end tool position ETP may correspond to or be proximate to the position of the end tool mounting configuration ETMC (e.g., at or proximate to the distal end DE5 of the fifth arm portion 125, which may correspond to the distal end of the movable configuration MAC).

FIG. 2 is a block diagram of control and processing portions 200 of the system of FIG. 1, which include a motion control system 140 (e.g., which may also be a processing system) and which include at least portions of an external control system ECS. The motion control and processing system 140 is configured to control the end tool position ETP of the end tool ETL with a level of accuracy defined as a movement system accuracy. More specifically, the motion control and processing system 140 is generally configured to control the coordinates (e.g., x, y and z coordinates) of the end tool position ETP with the movement system accuracy based at least in part on utilizing the motion mechanisms 131-135 and position sensors SEN1-SEN5 for sensing and controlling the positions of the arm portions 121-125. In various implementations, the motion control and processing system 140 may include motion mechanism control and sensing portions 141-145 that may respectively receive signals from the respective position sensors SEN1-SEN5, for sensing the positions (e.g., angular positions, linear positions, etc.) of the respective arm portions 121-125, and/or may provide control signals to the respective motion mechanisms 131-135 (e.g., including motors, linear actuators, etc.) for moving the respective arm portions 121-125.

The motion control and processing system 140 may also receive signals from the end tool sensing portion ETSN. In various implementations, the end tool sensing portion ETSN may include circuitry and/or configurations related to the operations of the end tool ETL (e.g., for sensing a workpiece WP, etc.) As will be described in more detail below, in various implementations the end tool ETL (e.g., a touch probe, a scanning probe, a camera, etc.) may be utilized for contacting or otherwise sensing surface locations/positions/points on a workpiece WP, for which various corresponding signals may be received, determined and/or processed by the end tool sensing portion ETSN, which may provide corresponding signals to the motion control and processing system 140. In various implementations, the motion control and processing system 140 may include an end tool control and sensing portion 146 that may provide control signals to and/or receive sensing signals from the end tool sensing portion ETSN. In various implementations, the end tool control and sensing portion 146 and the end tool sensing portion ETSN may be merged and/or indistinguishable. In various implementations, the motion mechanism control and sensing portions 141-145 and the end tool control and sensing portion 146 may all provide outputs to and/or receive control signals from a movement system position and orientation processing portion 147 which may control and/or determine the overall positioning and orientation of the movable configuration MAC of the movement system 110 and corresponding position and orientation of the end tool ETL as part of the motion control and processing system 140. In various implementations, the position of the end tool ETL may be referenced as the end tool position ETP. In general, the motion control system 140 is configured to control the end tool position and orientation, based at least in part on controlling the movable configuration MAC so as to move at least a portion of the end tool ETL that is mounted to the end tool mounting configuration ETMC within a movement volume MV.

In various implementations, the metrology system 150 may be included with or otherwise added to a movement system 110 (e.g., as part of a retrofit configuration for being added to an existing movement system 110, etc.). In general, the metrology system 150 may be utilized to provide a determination of the position and orientation of the end tool ETL (e.g., with an improved level of accuracy relative to the accuracy of the movement system 110). More specifically, as will be described in more detail below, the metrology system 150 may be utilized to determine a relative position that is indicative of the metrology position coordinates of the end tool position ETP and an orientation of the end tool ETL, with an accuracy level that is better than the movement system accuracy.

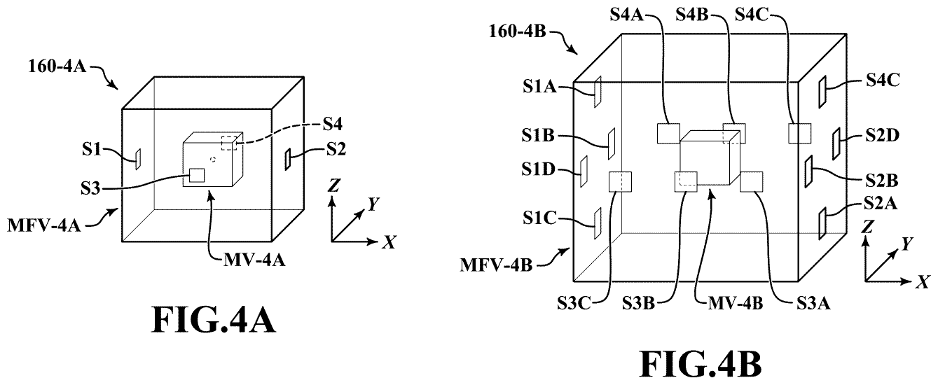

In various implementations, the sensor configuration 160 of the metrology system 150 includes light beam sensors S1-S4. In FIG. 1, the light beam sensors S1 and S2 are shown on the far left and right in the illustrated cross-sectional view, respectively, and the general positions of the light beam sensors S3 and S4 (e.g., which would be located out of and into the page, respectively) are indicated by a dotted line representation. As will be described in more detail below, FIG. 4A illustrates a three dimensional view of a sensor configuration 160-4A with four light beam sensors and a similar structure as the sensor configuration 160 of FIG. 1.

The light beam sensors S1-S4 are located at fixed positions (e.g., as may each be located on a frame, wall or other structure, etc.) which at least in part define a metrology frame volume MFV. The metrology frame volume MFV is configured to be located around at least part of the movement volume MV (e.g., in which the at least part of the end tool ETL is moved by the movement system 110). The light beam source configuration LC is configured to be operated (e.g., by a light beam source configuration control portion 192) to direct light beams to the light beam sensors S1-S4 of the sensor configuration 160 (e.g., to indicate a position and orientation of the light beam source configuration LC).

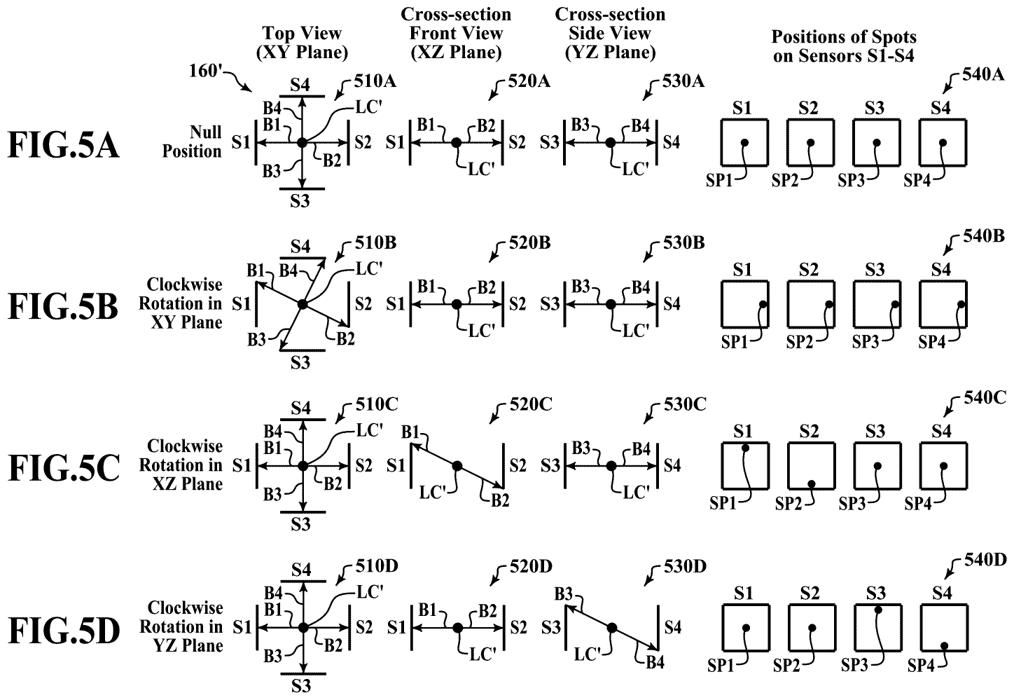

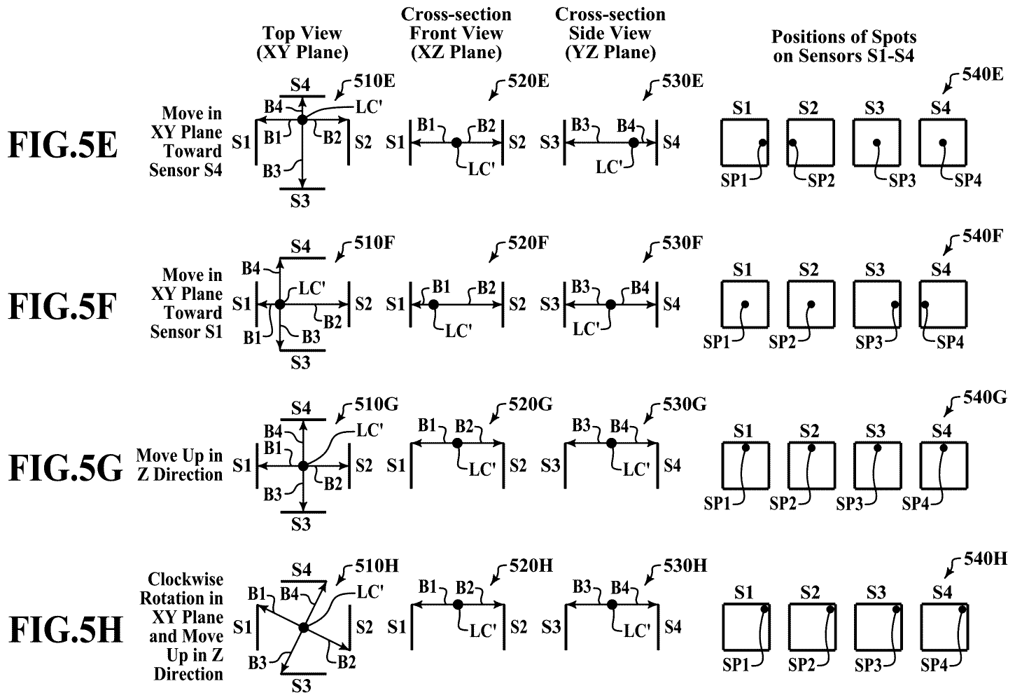

The light beam source configuration LC is configured to be coupled to at least one of the end tool ETL or the end tool mounting configuration ETMC. It will be appreciated that when the end tool ETL is coupled to the end tool mounting configuration ETMC, the light beam source configuration LC is then coupled to both the end tool ETL and the end tool mounting configuration ETMC. The position and orientation of the light beam source configuration LC are indicative of the position and orientation of the end tool ETL. As will be described in more detail below with respect to FIGS. 5A-5H, the light beams that are directed to the light beam sensors S1-S4 are configured to produce measurement spots SP in positions on the light beam sensors that cause the light beam sensors to produce corresponding measurement signals. The metrology system position and orientation processing portion 190 is configured to process the measurement signals from the light beam sensors S1-S4 of the sensor configuration 160, wherein the measurement signals from the light beam sensors S1-S4 indicate the position and orientation of the light beam source configuration LC, and correspondingly of the end tool ETL.

In various implementations, the movement volume MV consists of a volume in which at least a portion of at least one of the end tool ETL and/or the light beam source configuration LC may be moved. In the example of FIG. 1, the movement volume MV is illustrated as including a volume in which the contact point CP of the end tool ETL may be moved when inspecting a workpiece. As one alternative example, a movement volume may alternatively include a volume in which the light beam source configuration LC may move when the end tool ETL is moved for inspecting a workpiece. In various implementations, the movement system 110 is configured to move the movable configuration MAC so as to move at least a portion of an end tool ETL (e.g., including the contact point CP) that is mounted to the end tool mounting configuration ETMC along at least two dimensions (e.g., x and y dimensions) in the movement volume MV. In the example of FIG. 1, the portion of the end tool ETL (e.g., the contact point CP) is movable by the movement system 110 along three dimensions (e.g., x, y and z dimensions).

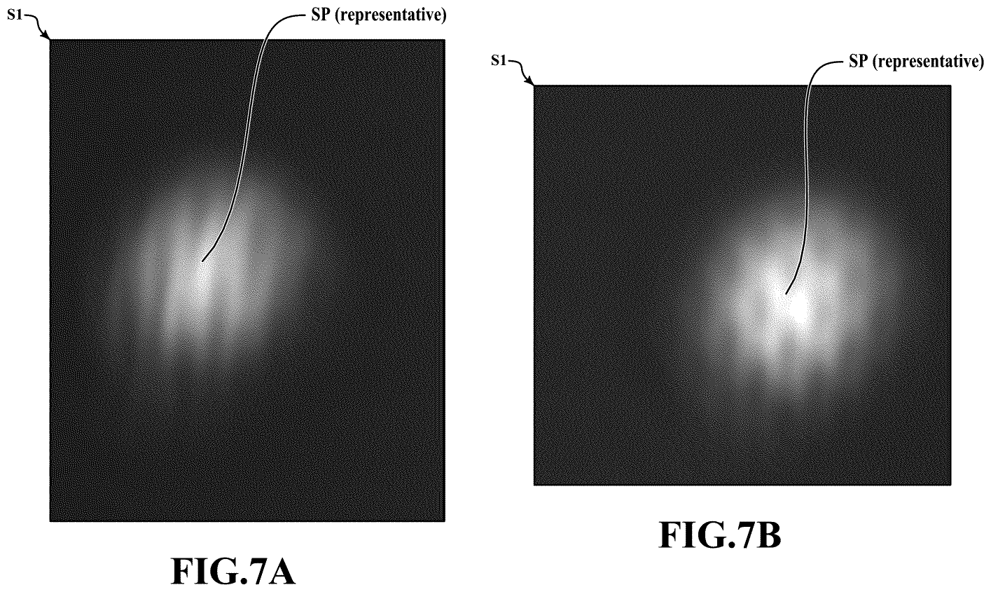

In various implementations, a latch portion 181 and/or the metrology system position and orientation processing portion 190 and/or the light beam source configuration control portion 192 may be included as part of an external control system ECS (e.g., as part of an external computer, etc.) The light beam source configuration control portion 192 may provide power and/or control signals to the light beam source configuration LC and/or portions thereof (e.g., to one or more light sources of the light beam source configuration LC, etc.) In various implementations, a modulation portion 192M may be included as part of the light beam source configuration control portion 192, or may otherwise be included as part of the metrology system, and may be utilized to modulate a current of one or more light sources of the light beam source configuration LC, as will be described in more detail below with respect to FIGS. 7A-11. The latch portion 181 may be included as part of a sensor configuration control and processing portion 180 (e.g., which may provide power and/or receive measurement signals from and/or provide control signals to the light beam sensors S1-S4 of the sensor configuration 160, and which may provide such signals and/or other signals to and from the metrology system position and orientation processing portion 190).

In various implementations, the latch portion 181 is configured to input at least one input signal that is related to the end tool position ETP and to determine the timing of a trigger signal based on the at least one input signal, and to output the trigger signal to at least one of the metrology system position and orientation processing portion 190 or the light beam sensors S1-S4 of the sensor configuration 160. In various implementations, the metrology system position and orientation processing portion 190 and/or the sensor configuration 160 are configured to determine current measurement signals from the light beam sensors S1-S4 (e.g., as corresponding to a current position and orientation of the light beam source configuration LC and/or end tool ETL) in response to receiving the trigger signal. In various implementations, the metrology system position and orientation processing portion 190 is configured to process the measurement signals as corresponding to the timing of the trigger signal to determine a position and orientation of the light beam source configuration LC and/or end tool ETL at the time of the trigger signal.

In various implementations, once a position and orientation of the light beam source configuration LC is determined, the position and orientation of the end tool may correspondingly be determined (e.g., in accordance with known geometric relationships, relative positioning, offsets etc. between the light beam source configuration LC and the end tool ETL). In various implementations, the light beam source configuration LC may be directly attached to the end tool ETL, or attached at or very close to the end tool mounting configuration (e.g., such that there is minimal or no separation between the end tool ETL and the light beam source configuration LC). In the implementation of FIG. 1, the light beam source configuration LC is illustrated as being at, or at least proximate to, the end tool position ETP (e.g., a designated reference position for the end tool ETL). Such configurations may reduce the complexity and/or otherwise improve the accuracy of a determination of the position and orientation of the end tool ETL as calculated in relation to a determined position and orientation of the light beam source configuration LC.

In various implementations, the determination of the position and orientation of the end tool ETL may further be utilized for determining certain additional position information (e.g., for determining the position of the contact point CP). As noted above, in various implementations, measurements of a workpiece surface may be determined by touching a contact point CP of an end tool ETL to a workpiece surface. In relation to such measurements, both the position and orientation of the end tool ETL may be determined, which may correspondingly indicate the position of the contact point CP.

In various implementations, different types of end tools ETL may provide different types of outputs that may be utilized with respect to the latch portion 181. For example, in an implementation where the end tool ETL is a touch probe that is used for measuring a workpiece and that outputs a touch signal when it touches the workpiece (e.g., when the contact point CP contacts the workpiece), the latch portion 181 may be configured to input that touch signal or a signal derived therefrom as the at least one input signal that the timing of a trigger signal is determined based on. In various implementations where the end tool ETL is a touch probe, a central axis of the touch probe may correspond to an end tool axis EA. As another example, in an implementation where the end tool ETL is a scanning probe that is used for measuring a workpiece and that provides respective workpiece measurement sample data corresponding to a respective sample timing signal, the latch portion 181 may be configured to input that respective sample timing signal or a signal derived therefrom as the at least one input signal. As another example, in an implementation where the end tool ETL is a camera that is used to provide a respective workpiece measurement image corresponding to a respective workpiece image acquisition signal, the latch portion 181 may be configured to input that workpiece image acquisition signal or a signal derived therefrom as the at least one input signal.

In various implementations, the metrology system 150 may be configured to determine the position and orientation of the light beam source configuration and/or end tool ETL, based on the measurement signals from the light beam sensors S1-S4 of the sensor configuration 160. It will be appreciated that such a system may have certain advantages over various alternative systems. For example, in various implementations a system such as that described herein may be smaller and/or less expensive and/or more accurate than certain alternative systems utilizing alternative technologies (e.g., including certain photogrammetry systems, etc.) as may alternatively be utilized for tracking movement system positions and orientations. The disclosed system also does not take up or obscure any part of the movement volume MV, in contrast to alternative systems that may include a scale or fiducial on the ground or stage, or otherwise in the same area (e.g., in the movement volume MV) where workpieces may otherwise be worked on and/or inspected, etc.

In various implementations, a comparison between a photogrammetry system and the metrology system 150 as disclosed herein may be described as follows. A photogrammetry system may utilize incoherent light sources, for which cameras are utilized to image the light sources, for determining the positions. In some instances, position and angle may be calculated from the source positions. The effective ‘lever arm’ for determining the angle is the distances between the sources. This is difficult to increase as it necessarily also increases the counteractive lever arm between the source and the lower portion of the end tool (e.g., corresponding to a distance, such as along an end tool axis EA direction, between the source and the contact point CP of the end tool). In other words, photogrammetry configurations which attempt to make it easier to measure the probe angle, also make the end tool position more sensitive to this angle. The camera's field of view in such systems may be the entire working volume, corresponding to a low magnification.

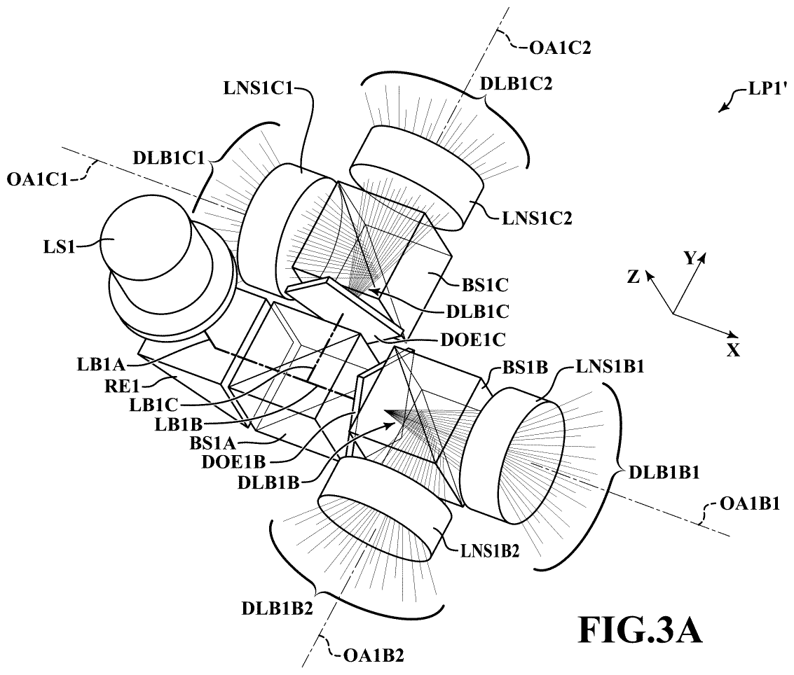

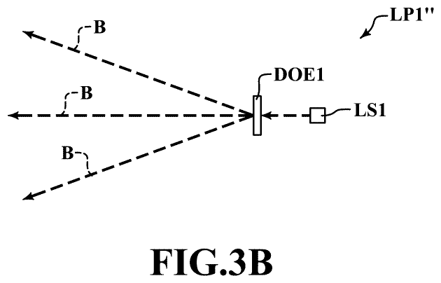

In contrast, in the metrology system 150 as disclosed herein, coherent light sources may typically be utilized. For example, the light sources for the light beam source configuration LC may be coherent light sources (e.g., laser light sources), for which the light beams may be coherent light beams (e.g., laser beams). Diffractive optical elements (e.g., as will be described in more detail below with respect to FIGS. 3A and 3B) may be utilized to produce many diffracted light beams (e.g., which can be dispersed in many directions surrounding the light source configuration LC). In various implementations, a relatively small fraction of the many diffracted or otherwise provided light beams may be directed to or otherwise received by the distributed light beam sensors of the metrology system 150 (e.g., to produce corresponding measurement spots SP on the light beam sensors). In various implementations, the light beam sensors may be various types of cameras and/or two dimensional position sensitive sensors (e.g., lensless cameras, position sensitive detectors, optical position sensors that can measure a position of a light spot in two-dimensions on a sensor surface, etc.) In operation, the large lever arms (e.g., corresponding in part to the distances between the light beam source configuration LC and the light beam sensors S) enable highly accurate orientation (e.g., corresponding to an angle of an end tool, etc.) measurements/determinations. In addition, the effective magnifications for such operations may be relatively high.

In various implementations, measurement signals from the light beam sensors (e.g., corresponding to images and/or indicating two dimensional positions of measurement spots SP formed by the light beams, for which a centroid of each measurement spot may be calculated/determined in terms of XYZ coordinates) may be utilized in combination with the known characteristics of the light beam source configuration LC (e.g., including laser projection based on the known geometric relationships of the light beams including the relative three dimensional angles of each light beam and accounting for any offsets of each light beam at its source, etc.) to calculate/determine the position and orientation (e.g., as based on using nonlinear least squares and/or other processing/calculation techniques). Stated another way, the known vectors of the light beams may be fit to the known locations (e.g., in XYZ coordinates) that they intersect on the light beam sensors (e.g., in terms of the positions of the measurement spots SP) to determine the position and orientation of the light beam source configuration LC. In various implementations, the measurement spots SP on the light beam sensors may each be uniquely identified (e.g., in part by utilizing coarse position information determined from the movement system 110, and/or based on unique or otherwise identifiable characteristics of the light beams, such as unique pattern information of the light beams, such as a pseudo-random pattern with unique or otherwise identifiable portions, etc.)

It will be appreciated that the combination of such features and characteristics of the metrology system 150 may result in higher accuracy position and orientation determinations than those provided by a photogrammetry system such as that described above. As some particular advantages, it is noted that the light beams as utilized in the metrology system 150 have corresponding orientation information that is lacking in photogrammetry and is more sensitive to the orientation (e.g., of the light beam source configuration LC and the end tool ETL). This can increase accuracy by a large amount.

FIG. 3A is a diagram of a first exemplary implementation of a light beam source portion LP1′ of a light beam source configuration LC (e.g., such as may be similar to the light beam source configuration LC utilized in the system of FIG. 1). As illustrated in FIG. 3A, the light beam source portion LP1′ includes a light source LS1, a reflective element RE1, beamsplitters BS1A, BS1B, BS1C, diffractive optical elements DOE1B, DOE1C, and lenses LNS1B1, LNS1B2, LNS1C1 and LNS1C2. In various implementations, the light source LS1 may be a laser source, for which at least some or all of the light beams in the following description may be laser beams. The light source LS1 produces a light beam LB1A, which is reflected by reflective element RE1 to be directed toward the beamsplitter BS1A, which splits the light beam into light beams LB1B and LB1C, which are directed to the diffractive optical elements DOE1B and DOE1C, respectively.

The light beam LB1B is diffracted by the diffractive optical element DOE1B into diffracted light beams DLB1B, which are split by beamsplitter BS1B into diffracted light beams DLB1B1 and DLB1B2. The diffracted light beams DLB1B1 further diverge after passing through the lens LNS1B1, which has an optical axis OA1B1, and the diffracted light beams DLB1B2 further diverge after passing through the lens LNS1B2, which has an optical axis OA1B2. Similarly, the light beam LB1C is diffracted by the diffractive optical element DOE1C into diffracted light beams DLB1C, which are split by beamsplitter BS1C into diffracted light beams DLB1C1 and DLB1C2. The diffracted light beams DLB1C1 further diverge after passing through the lens LNS1C1 which has an optical axis OA1C1, and the diffracted light beams DLB1C2 further diverge after passing through the lens LNS1C2, which has an optical axis OA1C2.

Orthogonal X, Y and Z axes are indicated (e.g., as corresponding to a coordinate system for the light beam source portion LP1′ and/or light beam source configuration). The optical axes OA1B1 and OA1C1 are indicated to be parallel to the X-axis, and the optical axes OA1B2 and OA1C2 are indicated to be parallel to the Y-axis.

In various implementations, the light beam source portion LP1′ may be a first light beam source portion, for which the corresponding light beam source configuration may include additional light beam source portions. For example, the light beam source configuration may include second and third light beam source portions (e.g., in some instances each having identical components as the first light beam source portion LP1′). In such a configuration, for the second light beam source portion, the respective optical axes may be parallel to the X-axis and the Z-axis, and for the third light beam source portion, the respective optical axes may be parallel to the Y-axis and the Z-axis. In such a configuration, there may thus be an approximately equal number of diffracted light beams directed by lenses with optical axes in the X-axis, Y-axis and Z-axis directions. Such a configuration may result in a relatively even distribution of light beams in directions from the light beam source configuration. In one implementation, if such a light beam source configuration were placed at a center of a sphere, there may be an approximately even dispersion around the surface of the sphere of intersection points where the light beams intersect with the surface of the sphere. In various implementations, it may be desirable for a light beam source configuration LC to provide at least a minimum number of light beams as dispersed in the directions surrounding the light beam source configuration LC (e.g., such as at least 10,000 light beams, or at least 100,000 light beams, etc.). In various implementations, a desired minimum number of light beams may depend on the light beam source configuration LC/light beam sensor distance, the number and size of the light beam sensors and the range of possible light beam source configuration LC orientations. In various implementations, it may be desirable for some or all of the light beams to have a similar or an approximately equal angular spacing relative to one another.

In various implementations, each of the light beams (e.g., each of the diffracted light beams DLB in the example of FIG. 3A) of a light beam source configuration may have certain known and/or determined characteristics (e.g., relative angular orientations, source points of origin, etc.) which spatially relate each light beam to the light beam source configuration. Such characteristics enable a position and orientation of the light beam source configuration to be determined, based at least in part on the light beams that are directed to and sensed by the light beam sensors of the sensor configuration. With regard to the light beam source portion LP1′, it is noted that the diffracted light beams may have certain offsets in relation to one another. For example, the diffracted light beams DLB1B1 may be modeled/regarded/designated as having a source point of origin that is offset along the Y-axis direction from a modeled/regarded/designated source point of origin for the diffracted light beams DLB1C1 (e.g., as related to the offset along the Y-axis direction between the lenses LNS1B1 and LNS1C1). It will be appreciated that such offsets may be included and/or otherwise accounted for in position calculations (e.g., including the processing/calculations as performed by the metrology system position and orientation processing portion 190 for processing the measurement signals from the light beam sensors to determine the position and orientation of the light beam source configuration LC and/or end tool ETL, etc.) Once a position and orientation of the light beam source configuration LC is determined, any known geometric relationships and/or relative positioning/offsets between the light beam source configuration LC and the end tool ETL may also be utilized for determining the position and orientation of the end tool ETL. As will be described in more detail below, FIGS. 5A-5H illustrate certain simplified examples regarding light beams B of a light beam source configuration LC as directed to sensors of a sensor configuration 160, and as corresponding to certain positions and orientations of a light beam source configuration LC.

FIG. 3B is a diagram of a second exemplary implementation of a light beam source portion LP1″ of a light beam source configuration LC (e.g., such as may be similar to the light beam source configuration LC utilized in the system of FIG. 1). In various implementations, FIG. 3B may be characterized as a simplified representation, such as in comparison to the representation of FIG. 3A. As illustrated in FIG. 3B, the light beam source portion LP1″ includes a light source LS1 and a diffractive optical element DOE1. The diffractive optical element DOE1 receives the light from the light source LS1, and diffracts the light to form a pattern of light beams B. In various implementations, a light beam source configuration LC may include a number of light beam source portions LP1″ (e.g., similar to the example configuration of the light beam source portion LP1′ of FIG. 3A in which a number of different sets of components are utilized for directing the light beams in the different directions).

FIGS. 4A and 4B are diagrams of respective movement volumes MV-4A and MV-4B as surrounded by respective metrology frame volumes MFV-4A and MFV-4B which are defined at least in part by respective sensor configurations 160-4A and 160-4B, which each include a respective different number of light beam sensors. In each case, the movement volume MV and metrology frame volume MFV are both represented as cubical volumes with the edges and sides parallel to the orthogonal X, Y, Z axis directions. It will be appreciated that while for simplicity of the illustrations the volumes and other aspects are shown with certain relative dimensions, that in various implementations the relative dimensions of the volumes and other aspects may vary (e.g., the illustrated dimensions may not be to scale, and for which the movement volumes MV may be larger in relation to the metrology frame volumes MFV, etc.)

FIG. 4A illustrates an implementation with a sensor configuration 160-4A including four light beam sensors S1-S4 (e.g., similar to the example implementation illustrated in FIG. 1, and also in relation to the examples of FIGS. 5A-5H, as will be described in more detail below). The four light beam sensors S1-S4 are disposed at positions that are all at a common middle Z-height along a Z-axis direction (i.e., all having a same Z-axis coordinate value). The light beam sensors S1 and S2 are disposed on opposite sides of the metrology frame volume and are parallel to a YZ plane. The light beam sensors S3 and S4 are disposed on opposite sides of the metrology frame volume and are parallel to an XZ plane.

FIG. 4B illustrates an implementation with a sensor configuration 160-4B including fourteen light beam sensors S1A-S1D, S2A-S2D, S3A-S3C and S4A-S4C. In relation to the sensor configuration 160-4A of FIG. 4A, the sensor configuration 160-4B of FIG. 4B may have higher measurement resolution and/or higher measurement accuracy along the X-axis direction (e.g., in accordance with the sets of three light beam sensors S3A-S3C, and S4A-S4C, as disposed at different positions along the X-axis direction on each respective side of the metrology frame volume MFV-4B). In addition, in further comparison to the sensor configuration of FIGS. 4A, the sensor configuration 160-4B of FIG. 4B may have higher measurement resolution and/or higher measurement accuracy along the Y-axis direction (e.g., in accordance with the sets of two light beam sensors S1B and S1D, and S2B and S2D, as disposed at different positions along the Y-axis direction on each respective side of the metrology frame volume MFV-4B, and as compared to the configuration of FIG. 4A with the utilization of the single light beam sensors S1 and S2 on each respective side). Furthermore, also in comparison to the sensor configuration of FIG. 4A, the sensor configuration 160-4B of FIG. 4B may also have higher measurement resolution and/or higher measurement accuracy along the Z-axis direction (e.g., in accordance with the sets of two light beam sensors S1A and S1C, and S2A and S2C, as disposed at different positions along the Z-axis direction on each respective side of the metrology frame volume MFV-4B, and as compared to the configuration of FIG. 4A with the utilization of the single light beam sensors S1 and S2 on each respective side).

FIGS. 5A-5H are diagrams illustrating a light beam source configuration LC′ that directs four example light beams B1-B4 toward four light beam sensors S1-S4 of a sensor configuration 160′ and which produce four corresponding measurement spots SP1-SP4 for different positions and orientations of the light beam source configuration LC′. In various implementations, the sensor configuration 160′ may be similar to that of FIGS. 1 and 4A (e.g., with the four light beam sensors S1-S4 at least partly defining a corresponding cubical metrology frame volume MFV). FIGS. 5A-5H illustrate respective top views 510A-510H, cross-section front views 520A-520H, cross-section side views 530A-530H, and positions of measurements spots views 540A-540H (i.e., in accordance with a front view of the sensor surface of each of the respective light beam sensors S1-S4).

In various implementations, the examples of FIGS. 5A-5H may also be illustrative of operations of sensor configurations with a greater number of light beam sensors, for which the following described examples may be illustrative of the operations of four (e.g., the four most central light beam sensors, etc.) out of the total number of light beam sensors in the given configurations. The examples of FIGS. 5A-5H may also be illustrative of operations of light beam source configurations with a greater number of light beams (e.g., 10's, 100's, or 1000's, etc. of light beams, such as may in some instances be directed in relatively evenly distributed three dimensional directions, such as described above with respect to FIG. 3A). In regard to such implementations, the following described examples may be illustrative of the operations of four (e.g., the four most central light beams and/or the four light beams specifically oriented along the X and Y axis directions, etc.) out of the total number of light beams in the given configurations. It will also be appreciated with respect to the examples of FIGS. 5A-5H, that the relative sizes of the light beam sensors S1-S4 appear exaggerated, the relative distances between the light beam sensors appear reduced, and that no offsets are indicated between the source points for the different light beams B1-B4, for purposes of simplifying the illustrated examples.

In the example of FIG. 5A, the light beam source configuration LC′, and the corresponding light beams B1-B4, are illustrated as being in a designated “null” position (e.g., including a corresponding “null” orientation). More specifically, the light beams B1 and B2 are each parallel to the X-axis direction, and are each directed to the centers of the light beam sensors S1 and S2, respectively. Similarly, the light beams B3 and B4 are each parallel to the Y-axis direction, and are each directed to the centers of the light beam sensors S3 and S4, respectively. The light beams B1-B4 produce corresponding measurement spots SP1-SP4 in the centers of each of the light beam sensors S1-S4, respectively. In various implementations, the light beam sensors S1-S4 may be various types of cameras and/or two dimensional position sensitive sensors (e.g., optical position sensors that can measure a position of a measurement spot, such as formed by a light beam, in two-dimensions on a sensor surface).

The light beam sensors S1-S4 may output measurement signals that indicate that the measurement spots SP1-SP4 are in the centers of the light beam sensors S1-S4. Given the known geometric relationships between the light beams B1-B4 and the light beam source configuration LC′, the measurement signals from the light beam sensors S1-S4 indicate the position and orientation of the light beam source configuration LC′ (e.g., as corresponding to the position and orientation of the example of FIG. 5A). The measurement signals may be processed (e.g., by a processing portion 190), for which the processing may determine the position and orientation of the light beam source configuration LC′ and/or an end tool ETL to which the light beam source configuration LC′ is coupled (e.g., see FIG. 1), etc.

In the example of FIG. 5B (e.g., in comparison to the example of FIG. 5A), the light beam source configuration LC′ is illustrated as having been rotated clockwise in an XY plane. The view 510B (i.e., of the XY plane) illustrates the clockwise rotation and indicates the different positions of the light beams B1-B4 on the light beam sensors S1-S4. The view 540B illustrates the positions of the measurement spots SP1-SP4 on the light beam sensors S1-S4, as produced by the light beams B1-B4, respectively. More specifically, the measurement spots SP1-SP4 are shown to each have moved to the middle right of each of the light beam sensors S1-S4, respectively.

In the example of FIG. 5C (e.g., in comparison to the example of FIG. 5A), the light beam source configuration LC′ is illustrated as having been rotated clockwise in an XZ plane. The view 520C (i.e., of the XZ plane) illustrates the clockwise rotation and indicates the different positions of the light beams B1 and B2 on the light beam sensors S1 and S2. In the view 540C, the measurement spots SP1 and SP2 are illustrated as having moved to the middle top and middle bottom, respectively, of the light beam sensors S1 and S2, while the measurement spots SP3 and SP4 have remained in the centers of the light beam sensors S3 and S4, respectively.

In the example of FIG. 5D (e.g., in comparison to the example of FIG. 5A), the light beam source configuration LC′ is illustrated as having been rotated clockwise in a YZ plane. The view 530D (i.e., of the YZ plane) illustrates the clockwise rotation and indicates the different positions of the light beams B3 and B4 on the light beam sensors S3 and S4. In the view 540D, the measurement spots SP1 and SP2 have remained in the centers of the light beam sensors S1 and S2, respectively, while the measurement spots SP3 and SP4 are illustrated as having moved to the middle top and middle bottom, respectively, of the light beam sensors S3 and S4.

The examples of FIGS. 5B-5D are noted to each correspond at least to a change in orientation of the light beam source configuration LC′. In some implementations, the illustrated changes may not otherwise correspond to a change in position (e.g., depending on where a reference point is designated for the light beam source configuration LC′, which changes in position are determined in relation to). In the examples of FIGS. 5A-5H, in various implementations a reference point for a light beam source configuration may be designated as being at a geometric center, or other center, of the light beam source configuration.

In the example of FIG. 5E (e.g., in comparison to the example of FIG. 5A), the light beam source configuration LC′ is illustrated as having moved in the XY plane toward the light beam sensor S4. The view 510E (i.e., of the XY plane) illustrates the different positions of the light beams B1 and B2 on the light beam sensors S1 and S2. In the view 540E, the measurement spots SP1 and SP2 are illustrated as having moved to the middle right and middle left, respectively, of the light beam sensors S1 and S2, while the measurement spots SP3 and SP4 have remained in the centers of the light beam sensors S3 and S4, respectively.

In the example of FIG. 5F (e.g., in comparison to the example of FIG. 5A), the light beam source configuration LC′ is illustrated as having moved in the XY plane toward the light beam sensor S1. The view 510F (i.e., of the XY plane) illustrates the different positions of the light beams B3 and B4 on the light beam sensors S3 and S4. In the view 540F, the measurement spots SP1 and SP2 have remained in the centers of the light beam sensors S1 and S2, respectively, while the measurement spots SP3 and SP4 are illustrated as having moved to the middle right and middle left, respectively, of the light beam sensors S3 and S4.

In the example of FIG. 5G (e.g., in comparison to the example of FIG. 5A), the light beam source configuration LC′ is illustrated as having been moved up in the Z direction (i.e., parallel to the Z-axis). The views 520G and 530G (i.e., of the XZ plane and YZ plane, respectively) illustrate the different positions of the light beams B1 and B2 on the light beam sensors S1 and S2, respectively, and of the light beams B3 and B4 on the light beam sensors S3 and S4, respectively. In the view 540G, the measurement spots SP1-SP4 are illustrated as each having moved to the top center of the light beam sensors S1-S4, respectively.

In the example of FIG. 5H (e.g., in comparison to the example of FIG. 5A), the light beam source configuration LC′ is illustrated as having been rotated clockwise in the XY plane and moved up in the Z direction (i.e., parallel to the Z-axis). The view 510H (i.e., of the XY plane) illustrates the clockwise rotation and the different positions of the light beams B1-B4 on the light beam sensors S1-S4. The views 520H and 530H (i.e., of the XZ plane and YZ plane, respectively) illustrate the different positions of the light beams B1 and B2 on the light beam sensors S1 and S2, respectively, and of the light beams B3 and B4 on the light beam sensors S3 and S4, respectively. In the view 540H, the measurement spots SP1-SP4 are illustrated as each having moved to the top right corner the light beam sensors S1-S4, respectively.

As described above, the light beam sensors S1-S4 may output measurement signals that indicate the positions of each of the measurement spots SP1-SP4 on the respective light beam sensors S1-S4. Given the known geometric relationships between the light beams B1-B4 and the light beam source configuration LC′ (e.g., including the known angular orientations of the light beams B1-B4 as directed by and in relation to the light beam source configuration LC′ and in relation to each other), the positions of the measurement spots SP1-SP4 on the light beam sensors S1-S4 indicate the position and orientation of the light beam source configuration LC′ (e.g., as corresponding to the orientations in the examples of FIGS. 5A-5H). The measurement signals from the light beam sensors S1-S4 may be processed (e.g., by a processing portion 190), for which the processing may determine (e.g., at least in part utilizing the known geometric relationships, etc.) the position and orientation of the light beam source configuration LC′ and/or an end tool ETL to which the light beam source configuration LC′ is coupled (e.g., see FIG. 1), etc.

With respect to the measurement signals from the light beam sensors S1-S4 indicating the position and orientation of the light beam source configuration LC′, it will be appreciated that the simplified examples of FIGS. 5A-5H are all with respect to the light beams B1-B4 each being directed to the respective light beam sensor S1-S4. More specifically, in each example, the light beam B1 is directed to the light beam sensor S1, the light beam B2 is directed to the light beam sensor S2, the light beam B3 is directed to the light beam sensor S3 and the light beam B4 is directed to the light beam sensor S4. In these examples, it will be appreciated that if the light beam source configuration LC′ were rotated in the XY plane by 90 degrees, 180 degrees or 270 degrees, that similar measurement spots may be produced in similar locations on the light beam sensors S1-S4, for which it may be desirable to be able to disambiguate relative to (e.g., distinguish between) such possibilities.

For example, with respect to the orientation illustrated in FIG. 5A, and with the light beams B1-B4 each being directed to the respective light beam sensor S1-S4, it will be appreciated that the measurement signals indicating the that measurement spots SP1-SP4 are each in the centers of the respective light beam sensors S1-S4, respectively, uniquely indicate that the light beam source configuration LC′ is in the position and orientation illustrated in the views 510A-530A of FIG. 5A (e.g., corresponding to a “null position” in the given example). However, with respect to the top view 510A, if the configuration were rotated clockwise by 90 degrees in the XY plane, measurement spots SP would similarly be produced in the centers of the light beam sensors S1-S4. More specifically, the light beam B1 would produce a measurement spot SP1 at the center of the light beam sensor S4, the light beam B2 would produce a measurement spot SP2 at the center of the light beam sensor S3, the light beam B3 would produce a measurement spot SP3 at the center of the light beam sensor S1, and the light beam B4 would produce a measurement spot SP4 at the center of the light beam sensor S2. It will be appreciated that similar measurement spots at the centers of the light beam sensors S1-S4 as produced by different respective measurement beams may occur for similar clockwise rotations of the configuration in the XY plane of 180 degrees and 270 degrees, with respect to the initial orientation as illustrated in the top view 510A.

In order to disambiguate between the sets of measurement signals that would result from such orientations (e.g., which might otherwise appear relatively identical), it may be desirable for the system to be configured to determine (e.g., at least approximately) which light beams are generally directed toward which light beam sensors. As one approach for addressing such issues, position information from the movement system 110 may be utilized for the disambiguation. For example, in relation to the measurement system 110 as described above with respect to FIGS. 1 and 2, the position information determined from the positions sensors SEN1-SEN5 (e.g., as received by the movement system position and orientation processing portion 147), may be utilized to determine a coarse position and orientation of the end tool ETL and/or of the light beam source configuration LC (e.g., with a movement system accuracy). While the movement system accuracy may be lower than that desired for certain applications, it may be useful for the disambiguation (e.g., such as described in relation to the above examples). More specifically, the movement system accuracy may be able to provide coarse position information (e.g., indicating the coarse position and orientation of the end tool ETL and/or of the light beam source configuration LC), which may be utilized to determine which light beams are generally directed toward which light beam sensors.

Returning to the above examples, in an instance with the configuration of FIG. 5A where the measurement signals from the light beam sensors S1-S4 indicate that the measurement spots are all in the centers of the light beam sensors, the position and orientation information from the movement system may be utilized to disambiguate the possibilities for the orientation of the light beam source configuration LC′ (e.g., between being a 0 degree rotation as illustrated in FIG. 5A, or a 90 degree rotation, or a 180 degree rotation, or a 270 degree rotation). For example, the position and orientation information from the movement system 110 may be utilized to determine whether the measurement spot that is at the center of the light beam sensor S1 is produced by the light beam B1, B2, B3 or B4. As noted above, while the measurement system accuracy may be relatively low, it may effectively be utilized by the metrology system for disambiguating possibilities such as those described above (in accordance with the coarse position information provided by the movement system), and for which the metrology system may then effectively provide higher accuracy measurements in accordance with the processes such as those described herein.

In various implementations, a general characterization of the relationship between the measurement signals of the movement system 110 and the measurement signals of the metrology system 150 may be described as follows. The position and orientation information (e.g., including measurements) determined from one or more of the position sensors SEN1-SEN5 of the movement system 110 (i.e., with the movement system accuracy) may be characterized as providing relatively coarse scale information (e.g., including coarse scale measurements of position and orientation, etc.) The position and orientation information (e.g., including measurements) determined from the metrology system 150 (e.g., as based on measurement signals from the light beam sensors) may be characterized as providing relatively fine scale information (e.g., including fine scale measurements of position and orientation, etc.) In various implementations, the measurements of the two systems may be combined to provide high accuracy measurements over a relatively large non-ambiguity range (e.g., such as micron level accuracy over a cubed meter movement volume).

As some specific example values, in one example implementation the movement system may have a positioning accuracy/potential position error of approximately 100 microns (e.g., with a non-ambiguity range provided over a 1 meter cubed movement/measurement volume as a coarse scale range). In this example, the metrology system may be configured to be able to resolve a potential distance error of the coarse scale measurement, such as with a non-ambiguity range that is larger than the potential distance error (e.g., a non-ambiguity range larger than 100 microns in this example, and with micron level accuracy, as a fine scale range). In accordance with such example values, the measurements (e.g., position and orientation information) of the two systems may be combined, to provide high accuracy measurements (e.g., with the micron level accuracy over the 1 meter cubed movement volume).

In regard to a metrology system such as that described herein, such principles may also be generally described in terms of identifying/disambiguating which light beams of a light beam source configuration are directed to which light beam sensors (e.g., for a given measurement spot on a light beam sensor). In relation to the above example values, the positioning accuracy/potential position error of approximately 100 microns of the movement system (e.g., with a non-ambiguity range provided over a 1 meter cubed movement/measurement volume as a coarse scale range), may be sufficient for identifying/determining/disambiguating which light beams are directed to which light beam sensors. The non-ambiguity range of the metrology system (e.g., which is larger than 100 microns in the above example, and with micron level accuracy, as a fine scale range), may correspond to a range over which different positions and orientations of the light beam source configuration can be unambiguously determined (e.g., in accordance with measurement spots moving across or otherwise being in different respective positions on the light beam sensors, such as illustrated in part by the simplified examples of FIGS. 5A-5H).

As an alternative and/or in addition to the above noted implementations (e.g., in which position information from a movement system is utilized for disambiguation), the light beams may also or alternatively have certain characteristics which may be utilized for disambiguation (e.g., which enable determinations of which light beams are directed toward which light beam sensors). For example, the light beams may be arranged in a pattern (e.g., with unique portions). In various implementations, the light beams may also or alternatively have different wavelengths (e.g., colors), timings, modulation, structures, and/or other characteristics that may be sensed/identified and utilized to determine which light beams are directed to which light beam sensors (e.g., for which the light beam sensors may also have certain corresponding differentiation capabilities, such as including different color detectors, etc.) In various implementations, one or more of the characteristics (e.g., timing, modulation, etc.) of the light beams may be controlled by a light beam source configuration control portion 192 (e.g., see FIG. 2), which may provide associated signals (e.g., timing signals, etc.) to a sensor configuration control and processing portion 180 and/or a metrology system position and orientation processing portion 190 (e.g., to be utilized as part of the processing for receiving measurement signals from the light beam sensors and utilizing the measurement signals for determining which light beams are directed toward which light beam sensors).

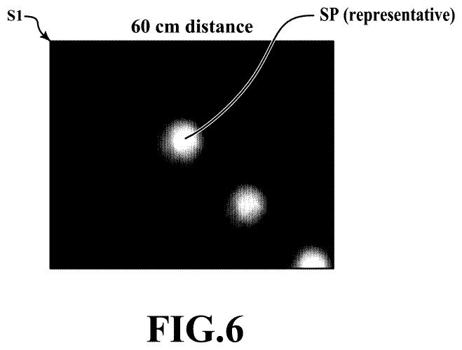

FIG. 6 is a diagram illustrating measurement spots SP as formed by light beams from a light beam source configuration on a first light beam sensor. In the example of FIG. 6, the light beam source configuration is at a distance (e.g., 60 cm) from the light beam sensor S1. As a result of the distance and the angular spacing/angular dispersion of the light beams, three measurement spots SP are produced on the light beam sensor S1. In the various implementations, a processing/monitoring of the area of each light beam sensor of the sensor configuration 160 may take a certain amount of time (e.g., including an amount of time needed to monitor/process/read out the data of all of the pixels of the pixel array of each of the light beam sensors). In some implementations, such processing may be characterized in terms of a number of frames per second for each of the light beam sensors. In various implementations, each of the light beam sensors may have an exposure time (e.g., which in some instances may be the same as or otherwise correspond to an integration time) during which the light beam sensor captures data (e.g., corresponding to an image, such as may include one or more measurement spots as formed on the light beam sensor).

For a system such as that illustrated by FIGS. 1-6, in accordance with principles as described above, it may be desirable for relatively “high quality” measurement spots (e.g., which are consistent and repeatable) to be produced from collimated (or approximately collimated) light beams from a diffractive optical element (e.g., DOE1, DOE1A, etc.) In various implementations, in order to precisely determine the position and orientation of the light beam source configuration (e.g., LC), it is desirable to be able to determine/measure the centers/centroids of the measurement spots to high precision (e.g., in relation to the principles for determining position and orientation as described above with respect to FIGS. 5A-5H).

In relation to such aspects, it has been determined that utilization of the modulation portion 192M to modulate the current of the light source (e.g., LS1) improves the accuracy of the determinations of the position and orientation of the light beam source configuration. Such improvement is believed to correspond to improved accuracy/consistency of the determinations of the centers/centroids of the measurement spots. In relation to such concepts, it is noted that certain unexpected aspects have been experimentally observed to occur. In particular, in some implementations it has been experimentally observed that certain amounts of structure may be occurring in the measurement spots as a result of certain factors (e.g., as will be described in more detail below with respect to FIGS. 7A-10). For example, it has been experimentally observed that when directing the light beam from the light source (e.g., which may include or otherwise be utilized in combination with a collimating lens) through the diffractive optical element (e.g., DOE1), the resulting measurement spots on the light beam sensors may include a certain amount of fine structure (e.g., which may correspondingly disturb, vary, or otherwise affect the positions and/or determinations of the centroids of the measurement spots).

One theory is that the fine structure may correspond to an interference effect, although it is noted that the structure exists even when the measurement spots are well separated, but possibly may be occurring due to internal reflections or other aspects within the diffractive optical element (e.g., DOE1). Of additional note in some implementations, it appears the structure may slowly change over time and/or distance (e.g., resulting in a drift of the centroids). This appears to occur even when the temperature of the light source is maintained at a relatively constant level. As will be described in more detail below, in accordance with the theory that this change in structure over time is occurring due to the wavelength of the light source drifting slightly, it is believed that the utilization of the modulation portion 192M to modulate the current of the light source (and correspondingly vary the light source wavelength over time) may be effectively “washing out” the structure or otherwise resulting in a more uniform density of the measurement spots over the exposure time of the light beam sensors. More specifically, if the changes in the structure over longer time frames are occurring due to certain “naturally” occurring variations in the operations of the corresponding components (e.g., due to drifts, etc.), then the utilization of the modulation portion to effectively cause such changes and/or similar/related changes to occur more rapidly (e.g., to cause the structure to be effectively averaged or “washed out” during the exposure times of the light beam sensors) may effectively correspond to the desirable results (e.g., of having the density of the measurement spots be more uniform and/or otherwise enabling more accurate/repeatable/consistent determinations of the position and orientation of the light beam source configuration).

FIGS. 7A and 7B are diagrams illustrating implementations of measurement spots with structure. As described herein, in various implementations, structure in a measurement spot may correspond to the measurement spot having variations (e.g., in intensity) that may be periodic or otherwise according to some type of pattern across the measurement spot (e.g., and as may correspond to an interference pattern or other phenomenon). In FIG. 7A, a measurement spot SP as formed on light beam sensor S1 is shown to have a certain amount of structure comprising certain interspersed vertical brighter and darker portions. As illustrated in FIG. 7B, a measurement spot SP as formed on the light beam sensor S1 includes structure comprising a series of smaller vertical brighter and darker portions (e.g., some of which are both horizontally and vertically interspersed). In some implementations, the structure illustrated in FIG. 7B may be characterized as approximating a type of waffle pattern, or lattice pattern, etc.

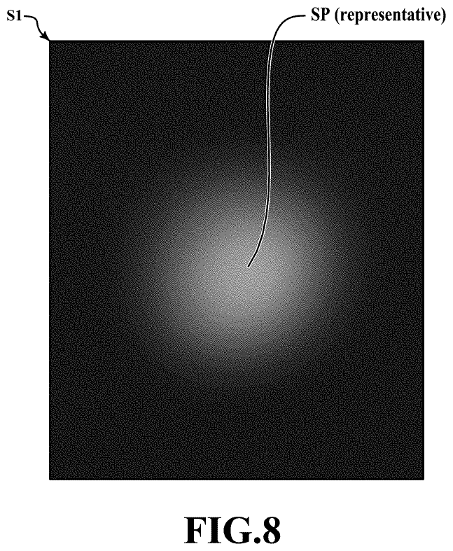

FIG. 8 is a diagram illustrating an implementation of a measurement spot as formed utilizing a modulation portion (e.g., in accordance with principles as described herein) which addresses certain issues related to the measurement spots of FIGS. 7A and 7B. As illustrated in FIG. 8, the measurement spot SP as formed on the light beam sensor S1 has a more uniform density in comparison to the measurement spots of FIGS. 7A and 7B (e.g., for which a centroid of the measurement spot may more accurately and consistently be determined, resulting in greater accuracy for determinations of the position and orientation of the light beam source configuration).

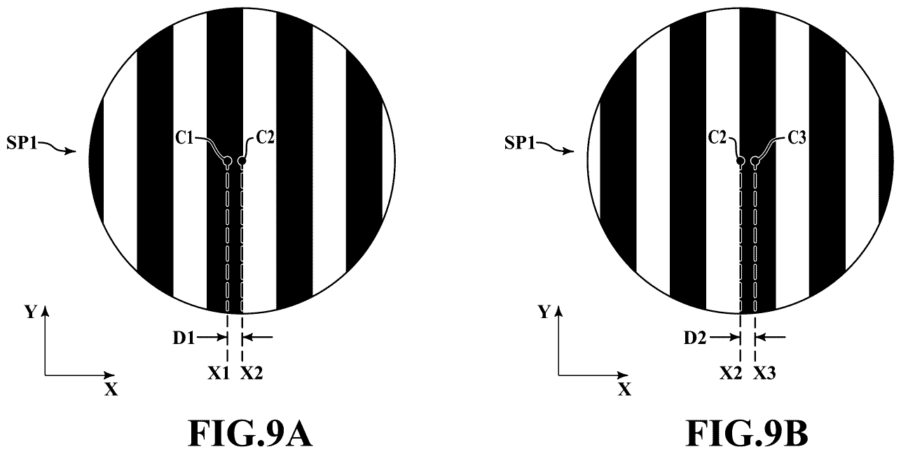

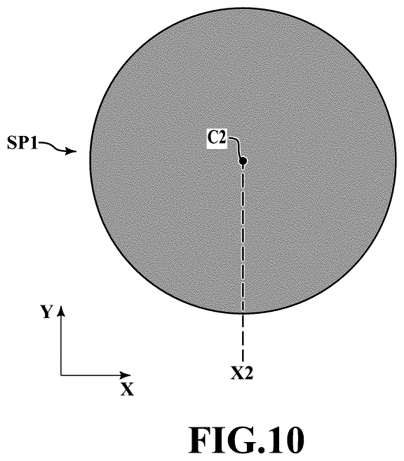

FIGS. 9A and 9B are diagrams illustrating a simplified example of measurement spots with structure. In the simplified example of FIG. 9A, the structure in the measurement spot SP1 is illustrated as consisting of vertical stripes. In the example of FIG. 9A, due to the structure, the centroid C1 of the white stripe portions of the measurement spot SP1 is at an x-axis position X1. It will be appreciated that the x-axis position may correspond to a position on a sensor S1, such as that of FIG. 5A, etc. In the examples of FIGS. 9A, 9B and 10, it will be appreciated that while centroids may have different x-axis and y-axis positions, for purposes of simplification of the examples, only the x-axis positions of the centroids are described. It will be appreciated that if there was no structure (e.g., no stripes) in the measurement spot SP1 of FIG. 9A (e.g., corresponding to a uniform density of the measurement spot), a centroid C2 of the measurement spot without the structure would be at a position X2 along the x-axis direction. As shown in FIG. 9A, a distance D1 indicates a difference (e.g., an amount of shift) of the centroid C1 that results due to the structure in the measurement spot, in comparison where the centroid C2 of the measurement spot would be without the illustrated structure.

FIG. 9B is similar to FIG. 9A, except in which the structure in the measurement spot has “shifted” or is otherwise different. More specifically, as illustrated in FIG. 9B, the measurement spot SP1 includes stripes in different positions than the structure of FIG. 9A, for which the structure of FIG. 9B in certain implementations may be characterized as corresponding to an approximately 180-degree phase shift of the stripes of FIG. 9A. In FIG. 9B, due to the positions of the stripes, the centroid C3 of the white stripe portions of the measurement spot is at a position X3 along the x-axis direction. It will be appreciated that a centroid C2 of the measurement spot without the structure would be at the position X2 along the x-axis direction (e.g., similar to that as illustrated and described with respect to FIG. 9A). As shown in FIG. 9B, a distance D2 indicates a difference (e.g., an amount of shift) of the centroid C3 that results due to the structure in the measurement spot, in comparison where the centroid C2 of the measurement spot would be without the illustrated structure.

FIG. 10 is a diagram illustrating a simplified example of a measurement spot as formed utilizing a modulation portion which addresses certain issues related to the measurement spots of FIGS. 9A and 9B. As described herein, in various implementations, the utilization of a modulation portion may cause certain structure within a measurement spot to vary in position over time (e.g., over an exposure time of a light beam sensor), which may result in a more uniform density of the measurement spot (e.g., as sensed by a light beam sensor over the corresponding exposure time). As illustrated in FIG. 10, this may result in the measurement spot SP1 appearing with a more uniform density (e.g., as appearing as a more uniform color, such as without the distinct stripes of the examples of FIGS. 9A and 9B). Thus, in accordance with the utilization of the modulation portion, the centroid C2 of the measurement spot SP1 may more accurately and consistently be determined at the position X2 along the x-axis direction (e.g., resulting in greater accuracy for determinations of the position and orientation of the light beam source configuration).

As noted above, for a system such as that described above, the utilization of a modulation portion (e.g., modulation portion 192M of FIG. 2) for modulating a current of a light source of the light beam source configuration results in improved accuracy and consistency for the determinations of the position and orientation of the light beam source configuration (e.g., in relation to the locations of the centroids of the measurement spots, etc.). In various implementations, it may have previously been assumed that modulating the current of a light source of the light beam source configuration may have generally been undesirable. More specifically, such modulations of the current are known to correspondingly result in corresponding modulations of the wavelength of the light beams of the light beam source configuration (e.g., for which the light beams pass through the diffractive optical element(s) and would result in certain modulations in the measurement spots, and correspondingly of the positions of the centroids of the measurement spots). However, it has been determined that such techniques may be utilized to address certain issues occurring in the system (e.g., such as related to structure in the measurement spots which was also unexpected).

More specifically, counter to expectations that the density of the measurement spots as produced by a version of the system of FIGS. 1-6 without the modulation portion 192M would be relatively uniform, as described above with respect to FIGS. 7A-10, it has been experimentally determined that there may be unexpected structure within the measurement spots. Furthermore, the structure may unexpectedly vary depending on time and/or distance between the light beam source configuration and a light beam sensor. For example, such structure may vary relatively slowly over time such that during a first exposure time of a first light beam sensor, the measurement spot as formed by a first light beam may have a first corresponding structure (e.g., such as illustrated by the examples of FIGS. 7A and 9A). Then, during a second exposure time of the first light beam sensor, the measurement spot formed by the first light beam (i.e., without the light beam source configuration having changed in position or orientation from the first exposure time) may have a second corresponding structure (e.g., such as illustrated by the examples of FIGS. 7B and 9B, and for which the second structure may correspond to a shifting or other change of the first corresponding structure). This changing structure is difficult to correct for, and if not addressed may otherwise result in unacceptably high errors/variations in the centroid position (e.g., as illustrated by the examples of FIGS. 9A and 9B).

In some instances, such structure may also or alternatively vary depending on a distance between the light beam source configuration and a light beam sensor on which a measurement spot is formed. For example, for a first distance between the light beam source configuration and the light beam sensor, the measurement spot as formed by a first light beam, may have a first corresponding structure (e.g., such as illustrated by the examples of FIGS. 7A and 9A). Then, at a second distance (i.e., of the light beam source configuration), the measurement spot formed by the first light beam may have a second corresponding structure (e.g., such as illustrated by the examples of FIGS. 7B and 9B, and for which the second structure may correspond to a shifting or other change of the first corresponding structure).

It is noted that it may be difficult to distinguish between effects occurring as a result of distance versus time, since measurement spots formed at different distances of the light beam source configuration necessarily are formed at different times, due to the time required to move the light beam source configuration from a first distance to a second distance. As noted above, the variations in structure that occur with time and/or distance appear to occur even when the temperature of the light source is maintained at a relatively constant level, thereby stabilizing the wavelength in relation to temperature changes. It is noted that if the structure was constant in distance and time (e.g., such as might be found in measurement spots that are slightly asymmetric due to optical misalignments, etc.), certain calibration/correction methods could be utilized for addressing the structure. However, such methods may generally be ineffective when dealing with structure that changes (e.g., relatively randomly) over time and/or distance (e.g., temporally changing structure).

It is also noted that in some instances, the structure and/or changes may be relatively subtle, such that it may be difficult to visually discern the structure and/or changes within the measurement spots (e.g., unlike the examples of FIGS. 7A, 7B, 9A and 9B which are intended to be more visually distinct as illustrative examples in relation to the described principles). Such relatively subtle structure and/or changes, while less visible, may still be significant enough to affect the accuracy of the determinations of the position and orientation of the light beam source configuration (e.g., by affecting the determinations of the centroids of the measurement spots as described above, etc.) As a potential further complication, it is noted that in some instances an orientation of a measurement spot and any corresponding structure may rotate (e.g., if the light beam source configuration rotates relative to the corresponding light beam sensor, such as around an axis that is generally directed toward the corresponding light beam sensor).

With respect to such issues, as noted above it has been determined that utilization of a modulation portion (e.g., modulation portion 192M) to modulate a current of a light source of the light beam source configuration effectively reduces the structure in the measurement spots as sensed by the light beam sensors and/or otherwise improves the accuracy and consistency of the determinations of the position and orientation of the light beam source configuration. It will be appreciated that principles as described herein (e.g., including utilization of the modulation portion 192M) may enable the system to utilize certain economical light sources, which may include a certain amount of inherent wavelength variation, but for which certain effects of the wavelength variation are addressed as described herein.

As noted above, one possible explanation for the structure that is experimentally observed in measurement spots as produced by the system, is that the structure may correspond to a type of interference pattern. The structure in the measurement spots may be wavelength dependent, and variations in the structure may in some instances correspond to the wavelength of the light source slowly changing over time. As a possibly related aspect, it is noted that the utilization of the diffractive optical elements in the system of FIGS. 1-6 is different than more common uses of such diffractive optical elements. For example, in common usage with a narrow depth of field (aka a narrow depth of focus), diffractive optical elements may more typically be utilized with tightly focused light beams, where a light source provides light through a focusing lens and for which the focused light is directed through a diffractive optical element which splits and directs corresponding focused light beams in different directions and as focused to points at specific distances. In such systems, in the focused points of light, any structure in the focused points may have been unrecognized or otherwise not considered as a significant factor, due to the very small size at the specific focus point.

In contrast, in the present application with a very large depth of field (aka a vary large depth of focus), in various implementations the light beams may be collimated, or at least approximately collimated (e.g., utilizing a collimating lens and/or a lens that produces an approximately collimated/slightly diverging light beam). More specifically, in the present system, it is desirable for the measurement spots as formed on the light beam sensors to remain at certain sizes over a wide range of distances. For example, such a wide range of distances may occur as the light beam source configuration LC is moved within the movement volume MV to different distances from the respective light beam sensors. In accordance with such principles (e.g., as related to the utilization of the measurement spots with relatively larger sizes than focused points), the unexpected presence of structure within the measurement spots (e.g., as may vary with time and/or distance) may cause certain issues as described above. It is noted that such issues may be distinguished from those corresponding to speckle, such as may occur due to reflection or transmission through rough and/or diffusing surfaces, which in various implementations may generally not be a significant factor in a system such as that of FIGS. 1-6 as described above (e.g., which may not include such rough and/or diffusing surfaces in relation to the production of the measurement spots).

As described herein, the modulation of the current of the light source(s) of the light beam source configuration appears to be effective for reducing structure in the measurement spots and/or otherwise enabling more accurate and consistent determinations of the centroids of the measurement spots in relation to and as indicative of the position and orientation of the light beam source configuration. In various implementations, it is believed that this may at least in part occur due to the fact that the modulation of the current causes modulations in the wavelength, which when produced at a sufficiently fast rate relative to the exposure time of the light beam sensors, may result in the structure of the measurement spots correspondingly changing relatively rapidly during the exposure time (e.g., resulting in a more uniform density of the measurement spots, such as potentially corresponding to at least partially averaging or “washing out” the structure in the measurement spots).

As some specific example numerical values, in certain implementations, a range of exposure times that may be utilized for the light beam sensors may be between 0.1 milliseconds and 2 milliseconds. As another example, for certain higher speed light beam sensors, a shorter exposure time range may correspond to between 0.05 milliseconds to 0.5 milliseconds. A desired minimum modulation frequency (e.g. for the modulation of the current of the light source) may correspond to at least a few cycles/periods (e.g., at least 3) during each exposure time. In general, an optimum frequency may correspond to providing a relatively stable spectrum at relatively long time scales. In various implementations, for producing modulations at a specified amplitude/frequency/waveform, the modulation portion 192M may include a corresponding configuration of electronic circuitry and/or components for producing the specified modulations of the current of the light source(s).

As some more specific numerical examples, in one implementation of the system, the current may be modulated by 1.5% at 2 kilohertz. In an implementation with a 2 milliseconds exposure time, such may correspond to producing approximately 4 modulation cycles over the exposure time. As another specific numerical example, in one implementation the current may be modulated by approximately 5% at 140 kilohertz. Such may result in 3 modulation cycles for a 0.02 milliseconds exposure time of the light beam sensor. Longer exposure times of the light beam sensor (e.g., within a range of 0.05 milliseconds to 2 milliseconds) may correspondingly have more modulation cycles occurring within the exposure time. In various implementations, it may be desirable for the system to have at least a few modulation cycles (e.g., at least 3 modulation cycles) per exposure time of the light beam sensors. As another specific numerical example, for an exposure time of 0.1 milliseconds, if it is desired to have three periods/cycles of the modulation occur over the exposure time, it may be desirable to utilize a modulation of at least 30 kilohertz (e.g., as approximately corresponding to three periods/cycles over the 0.1 milliseconds exposure time). Using similar calculations for a 2 milliseconds exposure time, it may be desirable to have the modulation be performed at at least 1.5 kilohertz.

In various implementations, it may be desirable to perform the modulations at values that are close to the recommended driving limits or other limits for the light source. In comparison, it is noted that the exposure time of human vision tends to be significantly slower than that of electronic light beam sensors. For example, certain techniques directed to human vision may be at slower rates such as 60 hertz or 120 hertz, etc., which is significantly slower than modulation rates such as those described above (e.g., in relation to achieving multiple cycles/periods of modulation within an exposure time of a light beam sensor).

In various implementations, a centroid calculation that is performed for measurement spots on light beam sensors may be characterized as a type of averaging, such as a type of center of mass calculation. Note that this spatial averaging does not ‘wash out’ the unwanted structure if it is at long length scales. More specifically, while the centroid calculation may be a type of averaging, it does not work the same way as a type of temporal averaging that is utilized in accordance with principles as described herein to ‘wash out’ the structure with modulation. This may especially be the case if the length scales of the structure are on the same order of magnitude as the overall measurement spot size.

In certain implementations, a centroid calculation process may begin with determining a highest intensity point or portion within the measurement spot. Determinations may then be made for intensities extending outward from the highest intensity point or portion, to find where the intensity drops below a designated threshold, for determining the general borders/area of the measurement spot. Then, in some implementations, the intensities may be squared or otherwise processed, and a threshold may be utilized to remove background values at the edges. Based on the intensities (e.g., in some instances including the squares of the intensities), a centroid of the measurement spot may be determined, such as in accordance with known centroid calculation techniques.

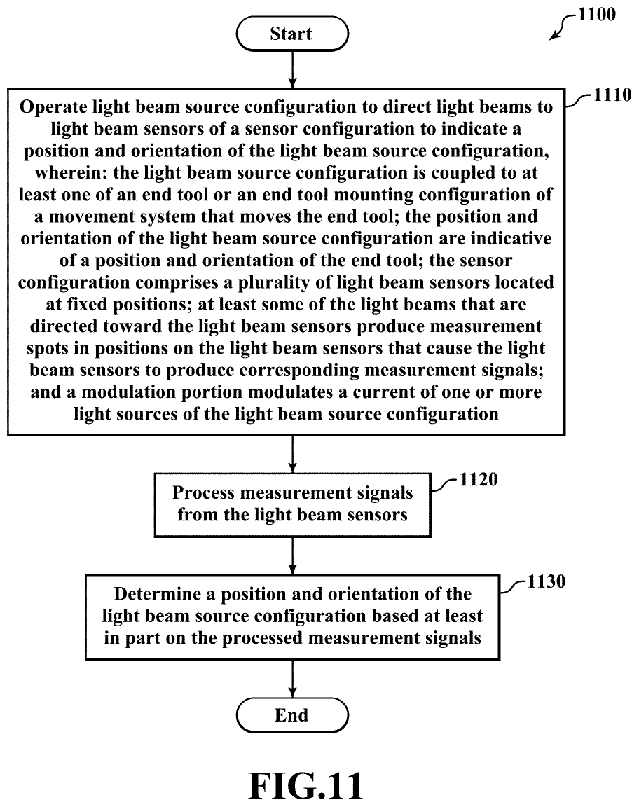

FIG. 11 is a flow diagram illustrating one exemplary implementation of a routine 1100 for operating a metrology system (e.g., for use with a movement system that moves an end tool). At a block 1110, a light beam source configuration is operated to direct light beams to light beam sensors of a sensor configuration to indicate a position and orientation of the light beam source configuration. As described above, the light beam source configuration is coupled to at least one of an end tool or an end tool mounting configuration of a movement system that moves the end tool. The position and orientation of the light beam source configuration are indicative of a position and orientation of the end tool. The sensor configuration comprises a plurality of light beam sensors located at fixed positions. At least some of the light beams that are directed toward the light beam sensors produce measurement spots in positions on the light beam sensors that cause the light beam sensors to produce corresponding measurement signals. A modulation portion (e.g., modulation portion 192M) modulates a current of one or more light sources of the light beam source configuration (e.g., in accordance with principles as described herein for enabling more consistently accurate determinations of the position and orientation of the light beam source configuration).

At a block 1120, measurement signals are processed from the light beam sensors (e.g., such as including or as related to determining centroids of measurement spots on the light beam sensors, etc.). At a block 1130, a position and orientation are determined of the light beam source configuration based at least in part on the processed measurement signals (e.g., in accordance with principles such as those described above with respect to FIGS. 5A-5H, and for which the accuracy of the determination of the position and orientation is higher than it would be if the modulation portion was not utilized to modulate a current of the one or more light sources of the light beam source configuration).

The following describes various exemplary embodiments of the present disclosure with various features and elements annotated with reference numerals found in FIGS. 1-11. It should be understood that the reference numerals are added to indicate exemplary embodiments, and the features and elements are not limited to the particular embodiments illustrated in FIGS. 1-11.

As described herein, a metrology system 100 is provided for use with a movement system 110 that moves an end tool ETL. The movement system 110 comprises a movable configuration MAC and a motion control system 140. The movable configuration MAC comprises an end tool mounting configuration ETMC that an end tool ETL is configured to mount to. The motion control system 140 is configured to control an end tool position and orientation, based at least in part on controlling the movable configuration MAC so as to move at least a portion of an end tool ETL that is mounted to the end tool mounting configuration ETMC within a movement volume MV.

The metrology system 100 comprises a sensor configuration 160, a light beam source configuration LC and a processing portion 190. The sensor configuration 160 comprises a plurality of light beam sensors (e.g., such as including light beam sensors S1-S4) located at fixed positions. The light beam source configuration LC is configured to direct light beams to light beam sensors of the sensor configuration 160 to indicate a position and orientation of the light beam source configuration LC. The light beam source configuration LC is configured to be coupled to at least one of an end tool ETL or the end tool mounting configuration ETMC. At least some light beams that are directed toward the light beam sensors are configured to produce measurement spots SP in positions on the light beam sensors that cause the light beam sensors to produce corresponding measurement signals. A modulation portion 192M (e.g., as included as part of a light beam source configuration control portion 192) is configured to modulate a current of one or more light sources (e.g., light source LS1) of the light beam source configuration LC.

The processing portion 190 is configured to process measurement signals from the light beam sensors of the sensor configuration 160 to determine a position and orientation of the light beam source configuration LC. In various implementations, the movement system 110 is configured to move the end tool ETL and correspondingly the light beam source configuration LC to a plurality of positions, and for each position the metrology system 100 is configured to: process measurement signals from sensing areas of the light beam sensors; and determine a position and orientation of the light beam source configuration LC based at least in part on the processed measurement signals.

In various implementations, the light beam sensors S1-S4 have an associated exposure time, and the modulations (i.e., as produced by the modulation portion 192M) occur at a rate for which a plurality of cycles of the modulations occur over the exposure time of the light beam sensors. As noted above, such modulations result in a reduction of the structure of the measurement spots as sensed by the light beam sensors, for which the laser current is modulated faster than the light beam sensor exposure time. For digital sensors, in various implementations the exposure time may generally be the same as, or nearly the same as, an integration time. In various implementations, the modulations are at a frequency of at least 2 kHz (or at least 5 kHz, or 10 kHz, or 20 kHz, or 50 kHz). In various implementations, the modulation portion 192M modulates the current by at least 1% (or at least 2%, or 3%, or 5%). In various implementations, the modulation portion 192M is configured to reduce structure that would otherwise be present in measurement spots as sensed by the light beam sensors S1-S4 if the current of the one or more light sources (e.g., light source LS1) was not modulated.

In various implementations, the processing of measurement signals from the light beam sensors S1-S4 of the sensor configuration to determine a position and orientation of the light beam source configuration LC comprises determining positions of centroids of at least some of the measurement spots as sensed by the light beam sensors. As described herein, the utilization of the modulation portion may affect the positions of the centroids of the measurement spots as sensed by the light beam sensors (e.g., such that a more accurate determination of the position and orientation of the light beam source configuration may be made as compared to if the modulation portion was not utilized to modulate a current of the one or more light sources of the light beam source configuration LC). In other words, in various implementations the accuracy of the determination of the position and orientation of the light beam source configuration may be increased by utilizing the modulation portion which affects the positions of the centroids.

In various implementations, the utilization of the modulation portion results in a more uniform density/improves the uniform density of the measurement spots as sensed by the light beam sensors over the exposure times. Such correspondingly affects the positions of the centroids of the measurement spots and makes the positions of the centroids of the measurement spots more consistent. As a result, a more accurate determination of the position and orientation of the light beam source configuration may be made, as compared to if the modulation portion was not utilized to modulate a current of the one or more light sources of the light beam source configuration LC.

In various implementations, for a first position and orientation of the light beam source configuration LC, the utilization of the modulation portion 192M results in a reduction in variance in positions of centroids of the measurement spots over time as sensed by the light beam sensors. This is in comparison to if the modulation portion was not utilized for which there would be a greater variance in the positions of the centroids of the measurement spots over time as sensed by the light beam sensors while the light beam source configuration remains at the first position and orientation. In various implementations, for a given position and orientation (e.g., a first position and orientation) of the light beam source configuration LC, the structure of the measurement spots may change over time (e.g., shifting over time) and for which the positions of the centroids of the measurement spots on the light beam sensors may correspondingly change over time (e.g., shifting in position over time). It is noted that this may be particularly problematic in relation to the exposure times of the light beam sensors.

More specifically, if after subsequent exposure times the positions of the centroids of the measurement spots on the light beam sensors have changed (i.e., even though the position and orientation of the light beam source configuration LC has not changed), such may result in an inaccurate determination that the light beam source configuration LC has moved (i.e., has changed position and/or orientation) when it has not. Also, in instances where the light beam source configuration LC has in fact moved, the determination of a current position and/or orientation and/or distance of movement from a previous position may have a level of inaccuracy that is at least in part dependent on the current positions of the centroids of the measurement spots on the light beam sensors (e.g., as may be shifting over time independent of the movement of the light beam source configuration).

In various implementations, the structure of the measurement spots may also change depending on the distance of the light beam source configuration LC from a given light beam sensor. More specifically, the structure of the measurement spots may change over distance (e.g., shifting over distance) and for which the positions of the centroids of the measurement spots on the light beam sensors may correspondingly change over distance (e.g., shifting in position over distance). If a light beam source configuration moves closer to or further from a light beam sensor (e.g., with a direction of movement along or parallel to an optical axis of the light beam forming the measurement spot), the centroid of the measurement spot should remain in the same position. However, if after such a movement toward or away from the light beam sensor the position of the centroid of the measurement spot on the light beam sensor has changed, such may result in an inaccurate determination (e.g., a determination that the orientation of the light beam source configuration relative to the light beam sensor has changed when it has not). Also, in instances where the light beam source configuration has in fact changed orientation relative to the light beam sensor, the determination of a current orientation (e.g., in relation to a previous orientation) may have a level of inaccuracy that is at least in part dependent on the current position of the centroid of the measurement spot on the light beam sensor (e.g., as may be shifting depending on changes in the distance of the light beam source configuration and/or as based on the timing as noted above).

As an example, in the illustration of FIG. 5E (e.g., in comparison to the illustration of FIG. 5A), the light beam source configuration LC′ is illustrated as having moved in the XY plane toward the light beam sensor S4, and correspondingly having moved away from the light beam sensor S3. In the view 540E (e.g., in comparison to the view 540A of FIG. 5A), the measurement spots SP3 and SP4 have remained in the centers of the light beam sensors S3 and S4, respectively. In this example, it is desirable that the centroids of the measurement spots SP3 and SP4 remain in the same positions on the light beam sensors S3 and S4 in the view 540E of FIG. 5E as compared to the view 540A of FIG. 5A. However, if after such a movement toward or away from the light beam sensors (e.g., toward the light beam sensor S4 and away from the light beam sensor S3) the position of the centroid of a measurement spot (e.g., measurement spots SP3 and SP4) on the light beam sensor has changed, such may result in an inaccurate determination (e.g., a determination that the orientation of the light beam source configuration LC′ relative to the light beam sensors S3 and S4 has changed when it has not). A similar example will be understood with respect to the illustration of FIG. 5F (e.g., in comparison to the illustration of FIG. 5A), and in relation to it being desirable that the positions of the centroids of the measurement spots SP1 and SP2 remain in the same positions on the light beam sensors S1 and S2 in the view 540F of FIG. 5F as compared to the view 540A of FIG. 5A.

As described herein, such issues may be addressed at least in part through the utilization of the modulation portion 192M to modulate a current of one or more light sources of the light beam source configuration. One theory as to the effectiveness of the modulation of the current of the light source, is that the system such as that illustrated in FIGS. 1-11 may have a certain amount of inherent modulation (e.g., wavelength instability due to “mode hopping” or other factors). Such effects may occur over relatively long time frames, such that for a given measurement spot on a given light beam sensor, the centroid of the measurement spot may move over time, such that it may be in a first position during a first light beam sensor exposure time (e.g., as illustrated in FIG. 9A), and may be in a second position during a second exposure time (e.g., as illustrated in FIG. 9B). In accordance with this theory, the modulation of the current, and correspondingly of the wavelength of the light beams, may effectively cause the instability as described above to occur at a faster time scale, such that the structure of the measurement spot changes during the exposure time (e.g., to effectively average, or “wash out” the structure over the exposure time of the light beam sensor).

As noted above, the modulation of the current may also or alternatively be effective for addressing distance effects. As noted above, such effects may occur at different distances, such that for a given measurement spot on a given light beam sensor, the position of the centroid of the measurement spot may be different at different distances, such that it may be in a first position at a first distance of the light beam source configuration from the light beam sensor (e.g., as illustrated in FIG. 9A), and may be in a second position at a second distance of the light beam source configuration from the light beam sensor (e.g., as illustrated in FIG. 9B). In accordance with this theory, the modulation of the current, and correspondingly of the wavelength of the light beams, may effectively cause the structure of the measurement spot to change during the exposure time for reasons such as those described above (e.g., to effectively average, or “wash out” the structure over the exposure time of the light beam sensor, to effectively address any difference in the structure at the first distance as compared to the second distance).

In various implementations, the light beams from the light beam source configuration LC are one of collimated or diverging (e.g., and are correspondingly not converging or otherwise focused to a particular point). As a result, as a distance between the light beam source configuration LC and a light beam sensor increases, the size (e.g., corresponding to the area) of the resulting measurement spot on the light beam sensor may generally either remain the same or increase (i.e., but generally does not decrease).

In various implementations, each of the light beam sensors (e.g., light beam sensors S1-S4) comprises a two dimensional position sensitive sensor, for which the measurement signals from the light beam sensors indicate the two dimensional positions of measurement spots SP on the light beam sensors that are produced by light beams. In various implementations, a metrology frame volume MFV is defined at least in part by the plurality of light beam sensors (e.g., light beam sensors S1-S4) located at the fixed positions, for which the metrology frame volume MFV is configured to surround at least part of the movement volume MV. In various implementations, the light beam source configuration LC comprises one or more diffractive optical elements DOE and at least some of the light beams from the light beam source configuration LC are diffracted light beams DLB.

In various implementations, the motion control system 140 may be configured to sense and control a position and orientation of the end tool ETL with a level of accuracy defined as a movement system accuracy, based at least in part on sensing and controlling the position and orientation of the end tool ETL using a plurality of position sensors SEN1-SEN5 included in the movable configuration MAC. The processing portion 190 may be operable to determine a position and orientation of the end tool ETL with an accuracy level that is better than the movement system accuracy, based at least in part on processing the measurement signals from the light beam sensors S1-S4. The light beams B directed by the light beam source configuration LC to the sensor configuration 160 may include a first light beam, and a determination of which light beam sensor the first light beam is directed to may be based at least in part on the sensed position and orientation (e.g., of the end tool ETL or the light beam source configuration LC) as determined by utilizing the plurality of position sensors SEN1-SEN5 included in the movable configuration MAC.

The light beam sensor that the first light beam is directed to may be a first light beam sensor S1, and the processing portion 190 may be operable to determine the position and orientation of the end tool ETL with an accuracy level that is better than the movement system accuracy, based at least in part on processing a first measurement signal from the first light beam sensor S1, for which the first measurement signal indicates a position of a first measurement spot SP as formed by the first light beam B on the first light beam sensor S1. The light beam sensor that the first light beam is directed to may be a first light beam sensor S1, and the processing portion 190 may be operable to determine the position and orientation of the end tool ETL with an accuracy level that results at least in part from the utilization of the modulation portion 192M, and for which the accuracy is higher than an accuracy that would result if the modulation portion 192M was not utilized (i.e., if the current of the light source(s) of the light beam source configuration was not modulated).

When the light beam source configuration LC is in a first position and a first orientation (e.g., see FIG. 5A), the light beams B from the light beam source configuration LC that are directed to the light beam sensors S1-S4 of the sensor configuration 160 may be configured to produce measurement spots SP in positions on the light beam sensors S1-S4 that cause the light beam sensors S1-S4 to produce a corresponding first set of measurement signals that indicates that the light beam source configuration LC is in the first position and the first orientation. In addition, when the light beam source configuration LC is in a second position and a second orientation that are different than the first position and the first orientation (e.g., see FIGS. 5B-5H), the light beams B from the light beam source configuration LC that are directed to the light beam sensors S1-S4 of the sensor configuration 160 may be configured to produce measurement spots SP in positions on the light beam sensors S1-S4 that cause the light beam sensors S1-S4 to produce a corresponding second set of measurement signals that is different than the first set of measurement signals and that indicates that the light beam source configuration LC is in the second position and the second orientation.

When the light beam source configuration LC is in the first position and the first orientation, the positions of the measurement spots SP on the light beam sensors S1-S4 may correspond to a first set of measurement spot positions (e.g., see views 540A of FIG. 5A), and when the light beam source configuration LC is in the second position and the second orientation, the positions of the measurement spots SP on the light beam sensors S1-S4 may correspond to a second set of measurement spot positions that is different than the first set of measurement spot positions (e.g., see views 540B-540H of FIGS. 5B-5H).

In various implementations, the sensor configuration 160 may comprise a first light beam sensor that is configured to: produce a first measurement signal when the light beam source configuration LC is in a first position and in a first orientation, for which the first measurement signal is produced by the first sensor based at least in part on the light beam source configuration LC directing a first light beam to form a measurement spot at a corresponding first position on the first light beam sensor (e.g., see FIG. 5A, with measurement spot SP1 as produced on sensor S1 by light beam B1); and produce a second measurement signal that is different than the first measurement signal when the light beam source configuration LC is in at least one of a second position that is different than the first position or a second orientation that is different than the first orientation, for which the second measurement signal is produced by the first sensor based at least in part on the light beam source configuration LC directing the first light beam to form a measurement spot at a corresponding second position that is different than the first position on the first light beam sensor (e.g., see FIG. 5B, 50, 5D, 5G or 5H, in each case with measurement spot SP1 as produced on sensor S1 by light beam B1).

The processing portion 190 may be configured to: determine that the light beam source configuration LC is in the first position and first orientation based at least in part on processing the first measurement signal from the first light beam sensor in combination with other measurement signals from the light beam sensors S1-S4 of the sensor configuration 160 (e.g., see FIG. 5A); and determine that the light beam source configuration LC is in the at least one of second position or second orientation based at least in part on processing the second measurement signal from the first light beam sensor in combination with other measurement signals from the light beam sensors S1-S4 of the sensor configuration 160 (e.g., see FIG. 5B, 5C, 5D, 5G or 5H).

According to a further aspect, a method is provided that includes generally three steps. The first step 1110 includes operating a light beam source configuration LC to direct light beams B to light beam sensors S1-S4 of a sensor configuration 160 to indicate a position and orientation of the light beam source configuration LC. It is noted that a modulation portion modulates a current of one or more light sources of the light beam source configuration LC. The second step 1120 includes processing the measurement signals from the light beam sensors S1-S4 of the sensor configuration 160 (e.g., in some implementations including determining centroids of measurement spots on the light beam sensors based on the measurement signals). A third step 1130 includes determining the position and orientation of the light beam source configuration LC based at least in part on the processed measurement signals (e.g., for which the accuracy of the determination of the position and orientation is higher than an accuracy that would result if the modulation portion was not utilized to modulate a current of the one or more light sources).

Position information may be received from the movement system that moves the end tool ETL, wherein the position information indicates a position of at least one of the end tool ETL or the light beam source configuration LC with a movement system accuracy, for which a determination of the position and orientation of at least one of the light beam source configuration LC or the end tool ETL is based at least in part on the position information from the movement system and the processing of the measurement signals from the light beam sensors S1-S4 of the sensor configuration 160.

While preferred implementations of the present disclosure have been illustrated and described, numerous variations in the illustrated and described arrangements of features and sequences of operations will be apparent to one skilled in the art based on this disclosure. Various alternative forms may be used to implement the principles disclosed herein. In addition, the various implementations described above can be combined to provide further implementations. All of the U.S. patents and U.S. patent applications referred to in this specification are incorporated herein by reference, in their entirety. Aspects of the implementations can be modified, if necessary to employ concepts of the various patents and applications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

1. A metrology system for use with a movement system that moves an end tool,
the movement system comprising:
a movable configuration comprising an end tool mounting configuration that an end tool is configured to mount to; and
a motion control system configured to control an end tool position and orientation, based at least in part on controlling the movable configuration so as to move at least a portion of an end tool that is mounted to the end tool mounting configuration within a movement volume,
the metrology system comprising:
a sensor configuration comprising a plurality of light beam sensors located at fixed positions;
a light beam source configuration that is configured to direct light beams to light beam sensors of the sensor configuration to indicate a position and orientation of the light beam source configuration, wherein:
the light beam source configuration is configured to be coupled to at least one of an end tool or the end tool mounting configuration; and
at least some light beams that are directed toward the light beam sensors are configured to produce measurement spots in positions on the light beam sensors that cause the light beam sensors to produce corresponding measurement signals;
a modulation portion configured to modulate a current of one or more light sources of the light beam source configuration; and
a processing portion configured to process measurement signals from the light beam sensors of the sensor configuration to determine a position and orientation of the light beam source configuration.

2. The metrology system of claim 1, wherein the modulation portion is included as part of a light beam source configuration control portion.

3. The metrology system of claim 1, wherein the light beam sensors have an associated exposure time, and the modulations occur at a rate for which a plurality of cycles of the modulations occur over the exposure time of the light beam sensors.

4. The metrology system of claim 1, wherein the modulations are at a frequency of at least 2 KHz.

5. The metrology system of claim 1, wherein the modulation portion modulates the current by at least 1%.

6. The metrology system of claim 1, wherein the modulation portion is configured to reduce structure that would otherwise be present in measurement spots as sensed by the light beam sensors if the current of the one or more light sources was not modulated.

7. The metrology system of claim 1, wherein the processing of measurement signals from the light beam sensors of the sensor configuration to determine a position and orientation of the light beam source configuration comprises determining positions of centroids of at least some of the measurement spots as sensed by the light beam sensors.

8. The metrology system of claim 7, wherein the utilization of the modulation portion affects the positions of the centroids of the measurement spots as sensed by the light beam sensors.

9. The system of claim 1, wherein each of the light beam sensors comprises a two dimensional position sensitive sensor, for which the measurement signals from the light beam sensors indicate the two dimensional positions of measurement spots on the light beam sensors that are produced by the light beams.

10. The metrology system of claim 1, wherein for a first position and orientation of the light beam source configuration, the utilization of the modulation portion results in a reduction in variance in positions of centroids of the measurement spots over time as sensed by the light beam sensors, in comparison to if the modulation portion was not utilized for which there would be a greater variance in the positions of the centroids of the measurement spots over time as sensed by the light beam sensors while the light beam source configuration remained at the first position and orientation.

11. The metrology system of claim 1, wherein the light beams from the light beam source configuration are one of collimated or diverging, such that as a distance between the light beam source configuration and a light beam sensor increases, the size of the resulting measurement spot on the light beam sensor either remains the same or increases.

12. The system of claim 1, wherein the light beam source configuration comprises one or more diffractive optical elements and at least some of the light beams from the light beam source configuration are diffracted light beams.

13. The system of claim 1, wherein the motion control system is configured to sense and control a position and orientation of the end tool with a level of accuracy defined as a movement system accuracy, based at least in part on sensing and controlling the position and orientation of the end tool using a plurality of position sensors included in the movable configuration.

14. The system of claim 13, wherein the light beams directed by the light beam source configuration to the sensor configuration include a first light beam, and a determination of which light beam sensor the first light beam is directed to is based at least in part on a sensed position and orientation as determined by utilizing the plurality of position sensors included in the movable configuration.

15. The system of claim 14, wherein the light beam sensor that the first light beam is directed to is a first light beam sensor, and the processing portion is operable to determine the position and orientation of the end tool with an accuracy level that is better than the movement system accuracy, based at least in part on processing a first measurement signal from the first light beam sensor, for which the first measurement signal indicates a position of a first measurement spot as formed by the first light beam on the first light beam sensor.

16. The system of claim 14, wherein the light beam sensor that the first light beam is directed to is a first light beam sensor, and the processing portion is operable to determine the position and orientation of the end tool with an accuracy level that results at least in part from the utilization of the modulation portion, and for which the accuracy is higher than an accuracy that would result if the modulation portion was not utilized to modulate a current of the one or more light sources of the light beam source configuration.

17. The system of claim 1, wherein the sensor configuration comprises a first light beam sensor that is configured to:
produce a first measurement signal when the end tool is in a first position and in a first orientation, for which the first measurement signal is produced by the first light beam sensor based at least in part on the light beam source configuration directing a first light beam to form a measurement spot at a corresponding first position on the first light beam sensor; and
produce a second measurement signal that is different than the first measurement signal when the end tool is in at least one of a second position that is different than the first position or a second orientation that is different than the first orientation, for which the second measurement signal is produced by the first light beam sensor based at least in part on the light beam source configuration directing the first light beam to form a measurement spot at a corresponding second position that is different than the first position on the first light beam sensor.

18. The system of claim 17, wherein the processing portion is configured to:
determine that the end tool is in the first position and first orientation based at least in part on processing the first measurement signal from the first light beam sensor in combination with other measurement signals from the light beam sensors of the sensor configuration; and
determine that the end tool is in the at least one of second position or second orientation based at least in part on processing the second measurement signal from the first light beam sensor in combination with other measurement signals from the light beam sensors of the sensor configuration.

19. A method for operating a metrology system for use with a movement system that moves an end tool,
the movement system comprising:
a movable configuration comprising an end tool mounting configuration that an end tool is configured to mount to; and
a motion control system configured to control an end tool position and orientation, based at least in part on controlling the movable configuration so as to move at least a portion of an end tool that is mounted to the end tool mounting configuration within a movement volume,
the method comprising:
operating a light beam source configuration of the metrology system to direct light beams to light beam sensors of a sensor configuration of the metrology system to indicate a position and orientation of the light beam source configuration, wherein:
the light beam source configuration is coupled to at least one of the end tool or the end tool mounting configuration of the movement system that moves the end tool;
the position and orientation of the light beam source configuration are indicative of a position and orientation of the end tool;
the sensor configuration comprises a plurality of light beam sensors located at fixed positions;
at least some of the light beams that are directed toward the light beam sensors produce measurement spots in positions on the light beam sensors that cause the light beam sensors to produce corresponding measurement signals; and
a modulation portion modulates a current of one or more light sources of the light beam source configuration; and
processing measurement signals from the light beam sensors; and
determining a position and orientation of the light beam source configuration based at least in part on the processed measurement signals.

20. A metrology system, comprising:
a sensor configuration comprising a plurality of light beam sensors located at fixed positions;
a light beam source configuration that is configured to direct light beams to the light beam sensors of the sensor configuration to indicate a position and orientation of the light beam source configuration, wherein:
the light beam source configuration is configured to be coupled to at least one of an end tool or an end tool mounting configuration of a movement system that moves the end tool;
the position and orientation of the light beam source configuration are indicative of a position and orientation of the end tool; and
at least some light beams that are directed toward the light beam sensors are configured to produce measurement spots in positions on the light beam sensors that cause the light beam sensors to produce corresponding measurement signals;
a modulation portion configured to modulate a current of one or more light sources of the light beam source configuration; and
a processing portion configured to process the measurement signals from the light beam sensors of the sensor configuration to determine a position and orientation of the light beam source configuration.
